(19) United States
(12) Patent Application Publication
(10) Pub. No.: US 2023/0087339 A1
(43) Pub. Date: Mar. 23, 2023

(54) SYSTEM AND METHOD FOR GENERATING AUTOMATIC INSIGHTS OF ANALYTICS DATA

(71) Applicant: ORACLE INTERNATIONAL CORPORATION, Redwood Shores, CA (US)

(72) Inventors: PHILIPPE LIONS, Venelles (FR); RAMESH VASUDEVAN, Los Altos, CA (US); RUTUJA JOSHI, Redwood City, CA (US); LALITHA VENKATARAMAN, Bangalore (IN); KALYAN BEEMANAPALLI, Eden Prairie, MN (US); NIKHIL SURVE, San Ramon, CA (US); LAXMINAG MAMILLAPALLI, Bangalore (IN); KENNETH ENG, Fremont, CA (US); ALAN RICHARDSON, Reading (GB)

(21) Appl. No.: 17/941,984

(22) Filed: Sep. 9, 2022

Related U.S. Application Data
(60) Provisional application No. 63/243,012, filed on Sep. 10, 2021.

(51) Int. Cl. G06F 16/26; G06F 16/22; G06F 16/2455; G06F 16/2458; G06F 16/25

(52) U.S. Cl. CPC G06F 16/26; G06F 16/221; G06F 16/24564; G06F 16/2462; G06F 16/254

(57) ABSTRACT

Described herein are systems and methods for generating automatic insights of analytics data. Generally, when data is uploaded or otherwise linked to or made accessible to an analytics environment, a skilled user is needed in order to generate meaningful data visualizations. The systems and methods described herein provide an automatic mechanism to generate for viewing and selection a set of meaningful data visualizations, wherein said generation is based upon a determined set of metrics, scored data columns, and scored visualizations.

### CLAIM OF PRIORITY

This application claims the benefit of priority to U.S. Provisional Patent Application titled “SYSTEM AND METHOD FOR GENERATING AUTOMATIC INSIGHTS OF ANALYTICS DATA”, Application No. 63/243,012, filed Sep. 10, 2021; which application and its content thereof is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to computer data analytics, computer-based methods of providing business intelligence data, and systems and methods for use with an analytic applications environment for generating automatic insights of analytics data.

### BACKGROUND

Data analytics enables computer-based examination of large amounts of data, for example to derive conclusions or other information from the data. For example, business intelligence tools can be used to provide users with business intelligence describing their enterprise data, in a format that enables the users to make strategic business decisions.

### SUMMARY

In accordance with an embodiment, described herein are systems and methods for generating automatic insights of analytics data. Generally, when data is uploaded or otherwise linked to or made accessible to an analytics environment, a skilled user is needed in order to generate meaningful data visualizations. The systems and methods described herein provide an automatic mechanism to generate for viewing and selection a set of meaningful data visualizations, wherein said generation is based upon a determined set of metrics, scored data columns, and scored visualizations.

### BRIEF DESCRIPTION OF THE DRAWINGS

FIG. 1 illustrates an example data analytics environment, in accordance with an embodiment.

FIG. 2 further illustrates an example data analytics environment, in accordance with an embodiment.

FIG. 3 further illustrates an example data analytics environment, in accordance with an embodiment.

FIG. 4 further illustrates an example data analytics environment, in accordance with an embodiment.

FIG. 5 further illustrates an example data analytics environment, in accordance with an embodiment.

FIG. 6 illustrates a use of the system to transform, analyze, or visualize data, in accordance with an embodiment.

FIG. 7 illustrates an example user interface for use with a data analytics environment, in accordance with an embodiment.

FIG. 8 illustrates an example user interface for use with a data analytics environment, in accordance with an embodiment.

FIG. 9 illustrates an example user interface for use with a data analytics environment, in accordance with an embodiment.

FIG. 10 illustrates an example user interface for use with a data analytics environment, in accordance with an embodiment.

FIG. 11 illustrates an example user interface for use with a data analytics environment, in accordance with an embodiment.

FIG. 12 illustrates an example user interface for use with a data analytics environment, in accordance with an embodiment.

FIG. 13 illustrates an example user interface for use with a data analytics environment, in accordance with an embodiment.

FIG. 14 illustrates an example user interface for use with a data analytics environment, in accordance with an embodiment.

FIG. 15 illustrates an example user interface for use with a data analytics environment, in accordance with an embodiment.

FIG. 16 illustrates an example user interface for use with a data analytics environment, in accordance with an embodiment.

FIG. 17 illustrates an example user interface for use with a data analytics environment, in accordance with an embodiment.

FIG. 18 illustrates an example user interface for use with a data analytics environment, in accordance with an embodiment.

FIG. 19 is a diagram of an overall flow of an automatic insights feature, in accordance with an embodiment.

FIG. 20 is a flowchart of a user experience of an automatic insights feature, in accordance with an embodiment.

FIG. 21 is a flowchart of a user experience of an automatic insights feature, in accordance with an embodiment.

FIG. 22 shows exemplary data visualizations for an automatic insights feature, in accordance with an embodiment.

FIG. 23 is a flowchart of a method for generating automatic insights of analytics data, in accordance with an embodiment.

### DETAILED DESCRIPTION

Generally described, within an organization, data analytics enables computer-based examination of large amounts of data, for example to derive conclusions or other information from the data. For example, business intelligence (BI) tools can be used to provide users with business intelligence describing their enterprise data, in a format that enables the users to make strategic business decisions.

Examples of such business intelligence tools/servers include Oracle Business Intelligence Applications (OBIA), Oracle Business Intelligence Enterprise Edition (OBIEE), or Oracle Business Intelligence Server (OBIS), which provide a query, reporting, and analysis server that can operate with a database to support features such as data mining or analytics, and analytic applications.

Increasingly, data analytics can be provided within the context of enterprise software application environments, such as, for example, an Oracle Fusion Applications environment; or within the context of software-as-a-service (SaaS) or cloud environments, such as, for example, an Oracle Analytics Cloud or Oracle Cloud Infrastructure environment; or other types of analytics application or cloud environments.

### INTRODUCTION

In accordance with an embodiment, a data warehouse environment or component, such as, for example, an Oracle Autonomous Data Warehouse (ADVV), Oracle Autonomous Data Warehouse Cloud (ADWC), or other type of data warehouse environment or component adapted to store large amounts of data, can provide a central repository for storage of data collected by one or more business applications.

For example, in accordance with an embodiment, the data warehouse environment or component can be provided as a multi-dimensional database that employs online analytical processing (OLAP) or other techniques to generate business-related data from multiple different sources of data. An organization can extract such business-related data from one or more vertical and/or horizontal business applications, and inject the extracted data into a data warehouse instance that is associated with that organization,

Examples of horizontal business applications can include ERP, HCM, CX, SCM, and EPM, as described above, and provide a broad scope of functionality across various enterprise organizations.

Vertical business applications are generally narrower in scope that horizontal business applications, but provide access to data that is further up or down a chain of data within a defined scope or industry. Examples of vertical business applications can include medical software, or banking software, for use within a particular organization.

Although software vendors increasingly offer enterprise software products or components as SaaS or cloud-oriented offerings, such as, for example, Oracle Fusion Applications; while other enterprise software products or components, such as, for example, Oracle ADWC, can be offered as one or more of SaaS, platform-as-a-service (PaaS), or hybrid subscriptions; enterprise users of conventional business intelligence applications and processes generally face the task of extracting data from their horizontal and vertical business applications, and introducing the extracted data into a data warehouse—a process which can be both time and resource intensive.

In accordance with an embodiment, the analytic applications environment allows customers (tenants) to develop computer-executable software analytic applications for use with a BI component, such as, for example, an OBIS environment, or other type of BI component adapted to examine large amounts of data sourced either by the customer (tenant) itself, or from multiple third-party entities.

As another example, in accordance with an embodiment, the analytic applications environment can be used to pre-populate a reporting interface of a data warehouse instance with relevant metadata describing business-related data objects in the context of various business productivity software applications, for example, to include predefined dashboards, key performance indicators (KPIs), or other types of reports.

### Data Analytics

Generally described, data analytics enables the computer-based examination or analysis of large amounts of data, in order to derive conclusions or other information from that data; while business intelligence tools (BI) provide an organization's business users with information describing their enterprise data in a format that enables those business users to make strategic business decisions.

Examples of data analytics environments and business intelligence tools/servers include Oracle Business Intelligence Server (OBIS), Oracle Analytics Cloud (OAC), and Fusion Analytics Warehouse (FAVV), which support features such as data mining or analytics, and analytic applications.

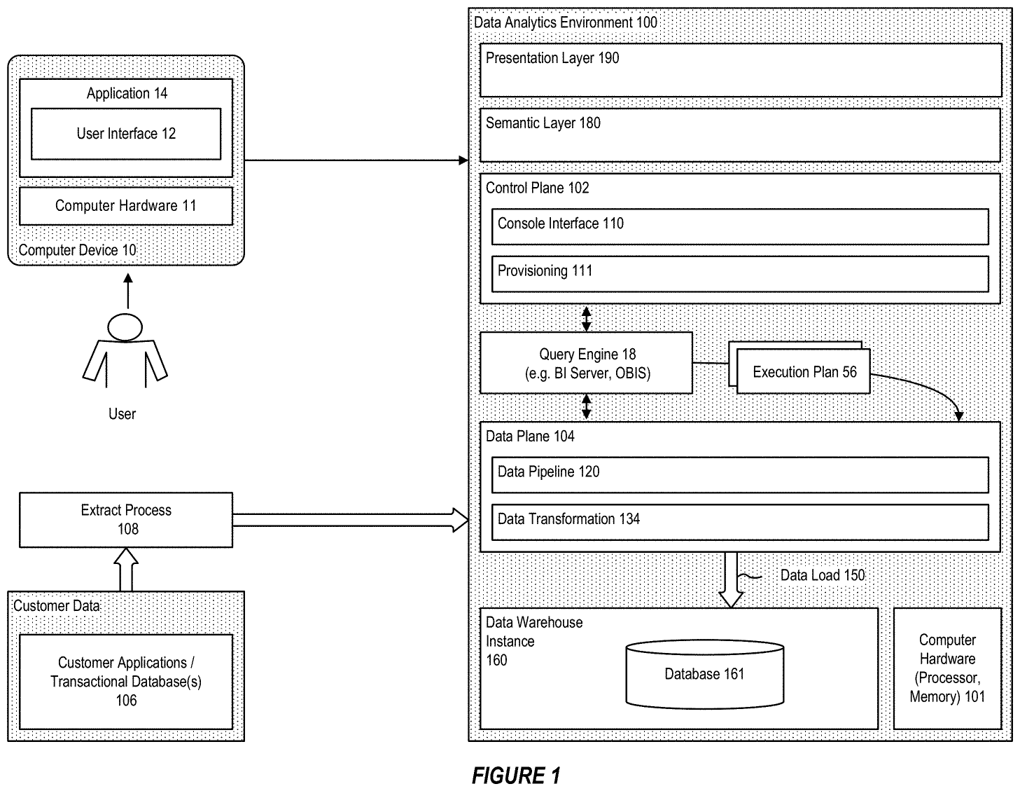

FIG. 1 illustrates an example data analytics environment, in accordance with an embodiment.

The example embodiment illustrated in FIG. 1 is provided for purposes of illustrating an example of a data analytics environment in association with which various embodiments described herein can be used. In accordance with other embodiments and examples, the approach described herein can be used with other types of data analytics, database, or data warehouse environments. The components and processes illustrated in FIG. 1, and as further described herein with regard to various other embodiments, can be provided as software or program code executable by, for example, a cloud computing system, or other suitably-programmed computer system.

As illustrated in FIG. 1, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access to a data warehouse, data warehouse instance 160 (database 161, or other type of data source).

In accordance with an embodiment, the control plane operates to provide control for cloud or other software products offered within the context of a SaaS or cloud environment, such as, for example, an Oracle Analytics Cloud environment, or other type of cloud environment. For example, in accordance with an embodiment, the control plane can include a console interface 110 that enables access by a customer (tenant) and/or a cloud environment having a provisioning component 111.

In accordance with an embodiment, the console interface can enable access by a customer (tenant) operating a graphical user interface (GUI) and/or a command-line interface (CLI) or other interface; and/or can include interfaces for use by providers of the SaaS or cloud environment and its customers (tenants). For example, in accordance with an embodiment, the console interface can provide interfaces that allow customers to provision services for use within their SaaS environment, and to configure those services that have been provisioned.

In accordance with an embodiment, a customer (tenant) can request the provisioning of a customer schema within the data warehouse. The customer can also supply, via the console interface, a number of attributes associated with the data warehouse instance, including required attributes (e.g., login credentials), and optional attributes (e.g., size, or speed). The provisioning component can then provision the requested data warehouse instance, including a customer schema of the data warehouse; and populate the data warehouse instance with the appropriate information supplied by the customer.

In accordance with an embodiment, the provisioning component can also be used to update or edit a data warehouse instance, and/or an ETL process that operates at the data plane, for example, by altering or updating a requested frequency of ETL process runs, for a particular customer (tenant).

In accordance with an embodiment, the data plane can include a data pipeline or process layer 120 and a data transformation layer 134, that together process operational or transactional data from an organization's enterprise software application or data environment, such as, for example, business productivity software applications provisioned in a customer's (tenant's) SaaS environment. The data pipeline or process can include various functionality that extracts transactional data from business applications and databases that are provisioned in the SaaS environment, and then load a transformed data into the data warehouse.

In accordance with an embodiment, the data transformation layer can include a data model, such as, for example, a knowledge model (KM), or other type of data model, that the system uses to transform the transactional data received from business applications and corresponding transactional databases provisioned in the SaaS environment, into a model format understood by the data analytics environment. The model format can be provided in any data format suited for storage in a data warehouse. In accordance with an embodiment, the data plane can also include a data and configuration user interface, and mapping and configuration database.

In accordance with an embodiment, the data plane is responsible for performing extract, transform, and load (ETL) operations, including extracting transactional data from an organization's enterprise software application or data environment, such as, for example, business productivity software applications and corresponding transactional databases offered in a SaaS environment, transforming the extracted data into a model format, and loading the transformed data into a customer schema of the data warehouse.

For example, in accordance with an embodiment, each customer (tenant) of the environment can be associated with their own customer tenancy within the data warehouse, that is associated with their own customer schema; and can be additionally provided with read-only access to the data analytics schema, which can be updated by a data pipeline or process, for example, an ETL process, on a periodic or other basis.

In accordance with an embodiment, a data pipeline or process can be scheduled to execute at intervals (e.g., hourly/daily/weekly) to extract transactional data from an enterprise software application or data environment, such as, for example, business productivity software applications and corresponding transactional databases 106 that are provisioned in the SaaS environment.

In accordance with an embodiment, an extract process 108 can extract the transactional data, whereupon extraction the data pipeline or process can insert extracted data into a data staging area, which can act as a temporary staging area for the extracted data. The data quality component and data protection component can be used to ensure the integrity of the extracted data. For example, in accordance with an embodiment, the data quality component can perform validations on the extracted data while the data is temporarily held in the data staging area.

In accordance with an embodiment, when the extract process has completed its extraction, the data transformation layer can be used to begin the transform process, to transform the extracted data into a model format to be loaded into the customer schema of the data warehouse.

In accordance with an embodiment, the data pipeline or process can operate in combination with the data transformation layer to transform data into the model format. The mapping and configuration database can store metadata and data mappings that define the data model used by data transformation. The data and configuration user interface (UI) can facilitate access and changes to the mapping and configuration database.

In accordance with an embodiment, the data transformation layer can transform extracted data into a format suitable for loading into a customer schema of data warehouse, for example according to the data model. During the transformation, the data transformation can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150, to load the transformed data into the customer schema of the data warehouse instance. Subsequent to the loading of the transformed data into customer schema, the transformed data can be analyzed and used in a variety of additional business intelligence processes.

Different customers of a data analytics environment may have different requirements with regard to how their data is classified, aggregated, or transformed, for purposes of providing data analytics or business intelligence data, or developing software analytic applications. In accordance with an embodiment, to support such different requirements, a semantic layer 180 can include data defining a semantic model of a customer's data; which is useful in assisting users in understanding and accessing that data using commonly-understood business terms; and provide custom content to a presentation layer 190.

In accordance with an embodiment, a semantic model can be defined, for example, in an Oracle environment, as a BI Repository (RPD) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, a customer may perform modifications to their data source model, to support their particular requirements, for example by adding custom facts or dimensions associated with the data stored in their data warehouse instance; and the system can extend the semantic model accordingly.

In accordance with an embodiment, the presentation layer can enable access to the data content using, for example, a software analytic application, user interface, dashboard, key performance indicators (KPI's); or other type of report or interface as may be provided by products such as, for example, Oracle Analytics Cloud, or Oracle Analytics for Applications.

### Business Intelligence Server

In accordance with an embodiment, a query engine 18 (e.g., an OBIS instance) operates in the manner of a federated query engine to serve analytical queries or requests from clients within, e.g., an Oracle Analytics Cloud environment, directed to data stored at a database.

In accordance with an embodiment, the OBIS instance can push down operations to supported databases, in accordance with a query execution plan 56, wherein a logical query can include Structured Query Language (SQL) statements received from the clients; while a physical query includes database-specific statements that the query engine sends to the database to retrieve data when processing the logical query. In this way the OBIS instance translates business user queries into appropriate database-specific query languages (e.g., Oracle SQL, SQL Server SQL, DB2 SQL, or Essbase MDX). The query engine (e.g., OBIS) can also support internal execution of SQL operators that cannot be pushed down to the databases.

In accordance with an embodiment, a user/developer can interact with a client computer device 10 that includes a computer hardware 11 (e.g., processor, storage, memory), user interface 12, and application 14. A query engine or business intelligence server such as OBIS generally operates to process inbound, e.g., SQL, requests against a database model, build and execute one or more physical database queries, process the data appropriately, and then return the data in response to the request.

To accomplish this, in accordance with an embodiment, the query engine or business intelligence server can include various components or features, such as a logical or business model or metadata that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, a query engine or business intelligence server may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine (e.g., OBIS) can process queries against a database according to a query execution plan, that can include various child (leaf) nodes, generally referred to herein in various embodiments as RqLists, for example:

```
Execution plan:
[[
RqList <<191986>> [for database 0:0,0]
  D102.c1 as c1 [for database 0:0,0],
  sum(D102.c2 by [ D102.c1] ) as c2 [for database 0:0,0]
Child Nodes (RqJoinSpec): <<192970>> [for database 0:0,0]
  RqJoinNode <<192969>> [ ]
    (
      RqList <<193062>> [for database 0:0,0]
        D2.c2 as c1 [for database 0:0,0],
        D1.c2 as c2 [for database 0:0,0]
      Child Nodes (RqJoinSpec): <<193065>> [for database 0:0,0]
        RqJoinNode <<193061>> [ ]
          (
            RqList <<192414>> [for database 0:0,118]
              T1000003.Customer_ID as c1 [for database 0:0,118],
              T1000003.TARGET as c2 [for database 0:0,118]
            Child Nodes (RqJoinSpec): <<192424>> [for database 0:0,118]
              RqJoinNode <<192423>> [ ]
                [users/administrator/dv_joins/multihub/input::##dataTarget]
                    as T1000003
          ) as D1 LeftOuterJoin (Eager) <<192381>> On D1.c1 = D2.c1;
            actual join vectors: [ 0 ] = [ 0 ]
          (
            RqList <<192443>> [for database 0:0,0]
              D104.c1 as c1 [for database 0:0,0],
              nullifnotunique(D104.c2 by [ D104.c1] ) as c2 [for database 0:0,0
            Child Nodes (RqJoinSpec): <<192928>> [for database 0:0,0]
              RqJoinNode <<192927>> [ ]
                (
                  RqList <<192852>> [for database 0:0,118]
                    T1000006.Customer_ID as c1 [for database 0:0,118],
                    T1000006.Customer_City as c2 [for database 0:0,118]
                  Child Nodes (RqJoinSpec): <<192862>> [for database 0:0,118]
                    RqJoinNode <<192861>> [ ]
                      [users/administrator/dv_joins/my_customers/input::data]
                        as T1000006
                ) as D104
            GroupBy: [ D104.c1] [for database 0:0,0] sort
            OrderBy: c1, Aggs: [ nullifnotunique(D104.c2 by [ D104.c1] ) ]
                [for database 0:0,0]
          ) as D2
    ) as D102
GroupBy: [ D102.c1] [for database 0:0,0] sort
OrderBy: c1 asc, Aggs:[ sum(D102.c2 by [ D102.c1] ) ] [for database 0:0,0]
```

Within a query execution plan, each execution plan component (RqList) represents a block of query in the query execution plan, and generally translates to a SELECT statement. An RqList may have nested child RqLists, similar to how a SELECT statement can select from nested SELECT statements.

In accordance with an embodiment, a query engine can talk to different databases, and for each of these use data-source-specific code generators. A typical strategy is to ship as much SQL execution to the database, by sending it as part of the physical query—this reduces the amount of information being returned to the OBIS server.

In accordance with an embodiment, during operation the query engine or business intelligence server can create a query execution plan which can then be further optimized, for example to perform aggregations of data necessary to respond to a request. Data can be combined together and further calculations applied, before the results are returned to the calling application, for example via the ODBC interface.

In accordance with an embodiment, a complex, multi-pass request that requires multiple data sources may require the query engine or business intelligence server to break the query down, determine which sources, multi-pass calculations, and aggregates can be used, and generate the logical query execution plan spanning multiple databases and physical SQL statements, wherein the results can then be passed back, and further joined or aggregated by the query engine or business intelligence server.

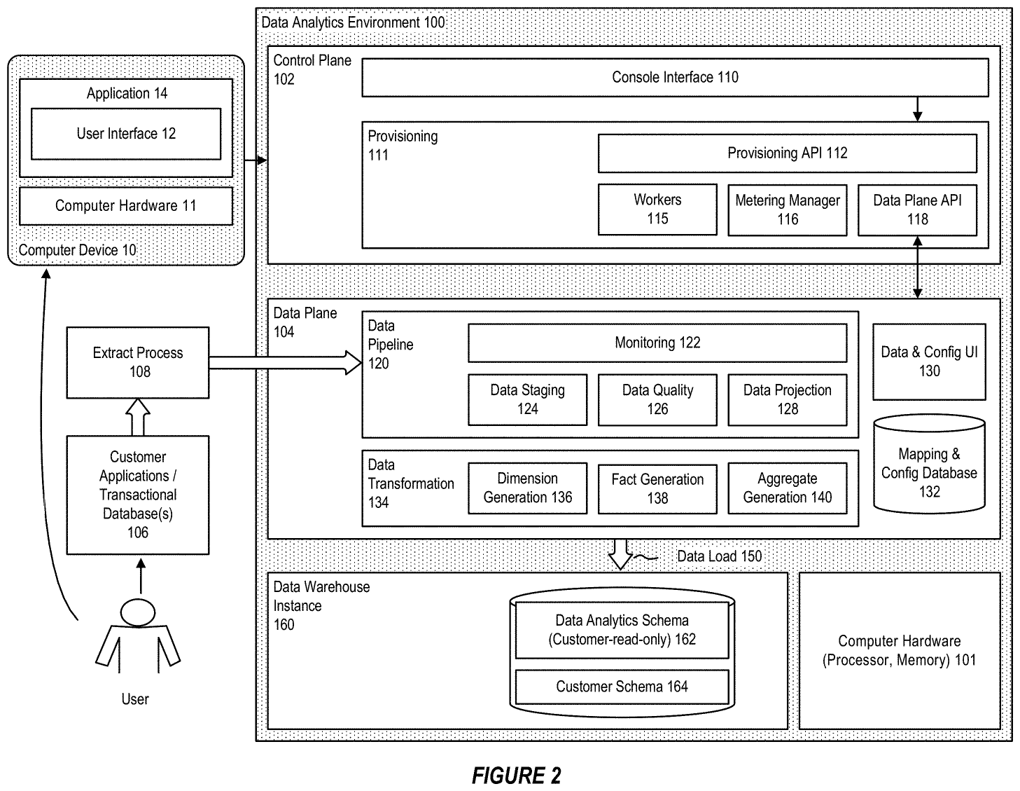

FIG. 2 further illustrates an example data analytics environment, in accordance with an embodiment.

As illustrated in FIG. 2, in accordance with an embodiment, the provisioning component can also comprise a provisioning application programming interface (API) 112, a number of workers 115, a metering manager 116, and a data plane API 118, as further described below. The console interface can communicate, for example, by making API calls, with the provisioning API when commands, instructions, or other inputs are received at the console interface to provision services within the SaaS environment, or to make configuration changes to provisioned services.

In accordance with an embodiment, the data plane API can communicate with the data plane. For example, in accordance with an embodiment, provisioning and configuration changes directed to services provided by the data plane can be communicated to the data plane via the data plane API.

In accordance with an embodiment, the metering manager can include various functionality that meters services and usage of services provisioned through control plane. For example, in accordance with an embodiment, the metering manager can record a usage over time of processors provisioned via the control plane, for particular customers (tenants), for billing purposes. Likewise, the metering manager can record an amount of storage space of data warehouse partitioned for use by a customer of the SaaS environment, for billing purposes.

In accordance with an embodiment, the data pipeline or process, provided by the data plane, can including a monitoring component 122, a data staging component 124, a data quality component 126, and a data projection component 128, as further described below.

In accordance with an embodiment, the data transformation layer can include a dimension generation component 136, fact generation component 138, and aggregate generation component 140, as further described below. The data plane can also include a data and configuration user interface 130, and mapping and configuration database 132.

In accordance with an embodiment, the data warehouse can include a default data analytics schema (referred to herein in accordance with some embodiments as an analytic warehouse schema) 162 and, for each customer (tenant) of the system, a customer schema 164.

In accordance with an embodiment, to support multiple tenants, the system can enable the use of multiple data warehouses or data warehouse instances. For example, in accordance with an embodiment, a first warehouse customer tenancy for a first tenant can comprise a first database instance, a first staging area, and a first data warehouse instance of a plurality of data warehouses or data warehouse instances; while a second customer tenancy for a second tenant can comprise a second database instance, a second staging area, and a second data warehouse instance of the plurality of data warehouses or data warehouse instances.

In accordance with an embodiment, based on the data model defined in the mapping and configuration database, the monitoring component can determine dependencies of several different datasets (also referred to herein as “data sets”) to be transformed. Based on the determined dependencies, the monitoring component can determine which of several different datasets should be transformed to the model format first.

For example, in accordance with an embodiment, if a first model dataset incudes no dependencies on any other model dataset; and a second model dataset includes dependencies to the first model dataset; then the monitoring component can determine to transform the first dataset before the second dataset, to accommodate the second dataset's dependencies on the first dataset.

For example, in accordance with an embodiment, dimensions can include categories of data such as, for example, “name,” “address,” or “age”. Fact generation includes the generation of values that data can take, or “measures.” Facts can be associated with appropriate dimensions in the data warehouse instance. Aggregate generation includes creation of data mappings which compute aggregations of the transformed data to existing data in the customer schema of data warehouse instance.

In accordance with an embodiment, once any transformations are in place (as defined by the data model), the data pipeline or process can read the source data, apply the transformation, and then push the data to the data warehouse instance.

In accordance with an embodiment, data transformations can be expressed in rules, and once the transformations take place, values can be held intermediately at the staging area, where the data quality component and data projection components can verify and check the integrity of the transformed data, prior to the data being uploaded to the customer schema at the data warehouse instance. Monitoring can be provided as the extract, transform, load process runs, for example, at a number of compute instances or virtual machines. Dependencies can also be maintained during the extract, transform, load process, and the data pipeline or process can attend to such ordering decisions.

In accordance with an embodiment, after transformation of the extracted data, the data pipeline or process can execute a warehouse load procedure, to load the transformed data into the customer schema of the data warehouse instance. Subsequent to the loading of the transformed data into customer schema, the transformed data can be analyzed and used in a variety of additional business intelligence processes.

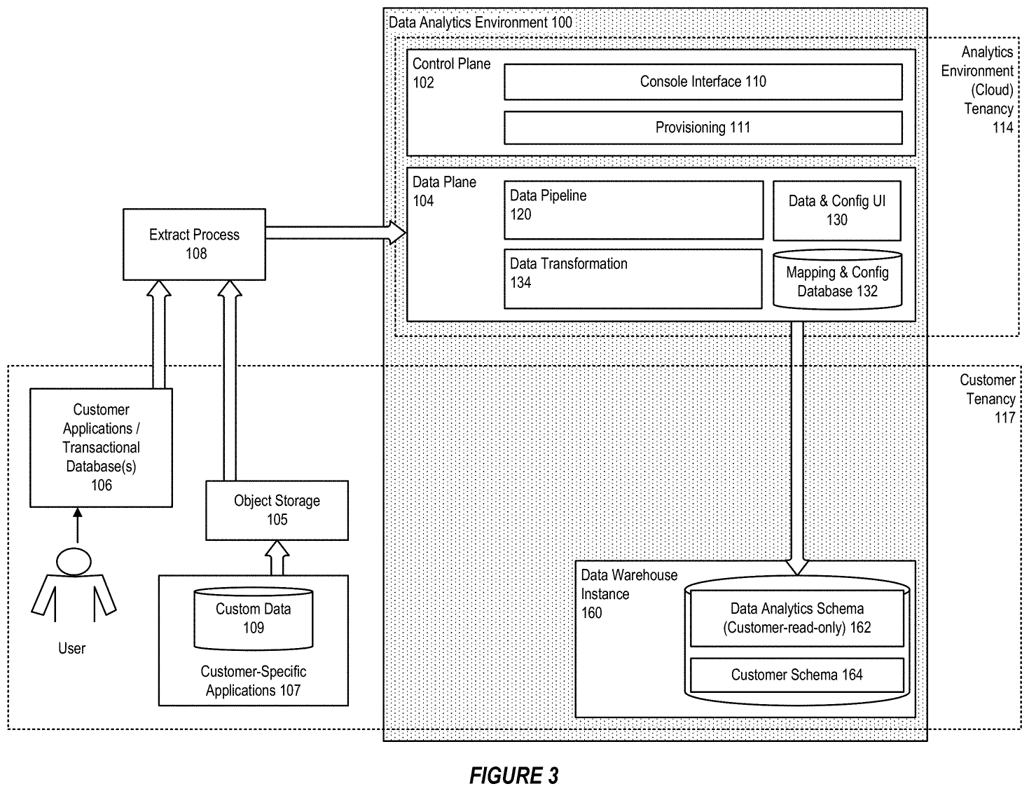

FIG. 3 further illustrates an example data analytics environment, in accordance with an embodiment.

As illustrated in FIG. 3, in accordance with an embodiment, data can be sourced, e.g., from a customer's (tenant's) enterprise software application or data environment (106), using the data pipeline process; or as custom data 109 sourced from one or more customer-specific applications 107; and loaded to a data warehouse instance, including in some examples the use of an object storage 105 for storage of the data.

In accordance with embodiments of analytics environments such as, for example, Oracle Analytics Cloud (OAC), a user can create a dataset that uses tables from different connections and schemas. The system uses the relationships defined between these tables to create relationships or joins in the dataset.

In accordance with an embodiment, for each customer (tenant), the system uses the data analytics schema that is maintained and updated by the system, within a system/cloud tenancy 114, to pre-populate a data warehouse instance for the customer, based on an analysis of the data within that customer's enterprise applications environment, and within a customer tenancy 117. As such, the data analytics schema maintained by the system enables data to be retrieved, by the data pipeline or process, from the customer's environment, and loaded to the customer's data warehouse instance.

In accordance with an embodiment, the system also provides, for each customer of the environment, a customer schema that is readily modifiable by the customer, and which allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse (e.g., ADW) can include a data analytics schema and, for each customer/tenant, a customer schema sourced from their enterprise software application or data environment. The data provisioned in a data warehouse tenancy (e.g., an ADW cloud tenancy) is accessible only to that tenant; while at the same time allowing access to various, e.g., ETL-related or other features of the shared environment.

In accordance with an embodiment, to support multiple customers/tenants, the system enables the use of multiple data warehouse instances; wherein for example, a first customer tenancy can comprise a first database instance, a first staging area, and a first data warehouse instance; and a second customer tenancy can comprise a second database instance, a second staging area, and a second data warehouse instance.

In accordance with an embodiment, for a particular customer/tenant, upon extraction of their data, the data pipeline or process can insert the extracted data into a data staging area for the tenant, which can act as a temporary staging area for the extracted data. A data quality component and data protection component can be used to ensure the integrity of the extracted data; for example by performing validations on the extracted data while the data is temporarily held in the data staging area. When the extract process has completed its extraction, the data transformation layer can be used to begin the transformation process, to transform the extracted data into a model format to be loaded into the customer schema of the data warehouse.

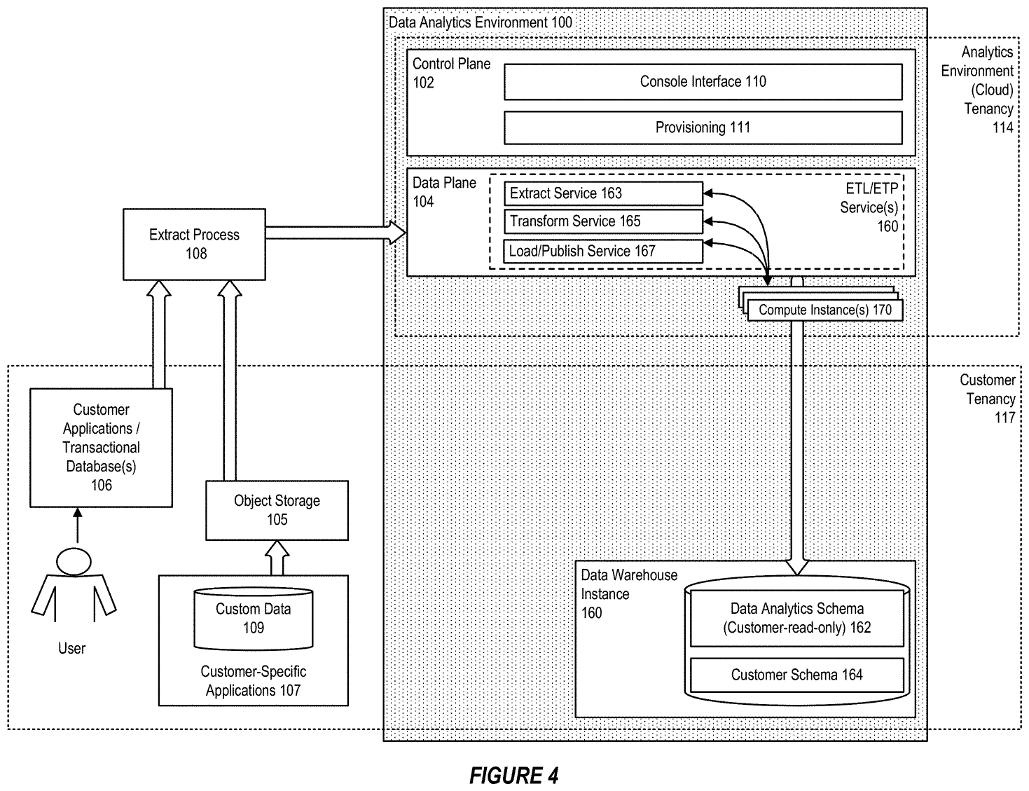

FIG. 4 further illustrates an example data analytics environment, in accordance with an embodiment.

As illustrated in FIG. 4, in accordance with an embodiment, the process of extracting data, e.g., from a customer's (tenant's) enterprise software application or data environment, using the data pipeline process as described above; or as custom data sourced from one or more customer-specific applications; and loading the data to a data warehouse instance, or refreshing the data in a data warehouse, generally involves three broad stages, performed by an ETP service 160 or process, including one or more extraction service 163; transformation service 165; and load/publish service 167, executed by one or more compute instance(s) 170.

For example, in accordance with an embodiment, a list of view objects for extractions can be submitted, for example, to an Oracle BI Cloud Connector (BICC) component via a REST call. The extracted files can be uploaded to an object storage component, such as, for example, an Oracle Storage Service (OSS) component, for storage of the data. The transformation process takes the data files from object storage component (e.g., OSS), and applies a business logic while loading them to a target data warehouse, e.g., an ADW database, which is internal to the data pipeline or process, and is not exposed to the customer (tenant). A load/publish service or process takes the data from the, e.g., ADW database or warehouse, and publishes it to a data warehouse instance that is accessible to the customer (tenant).

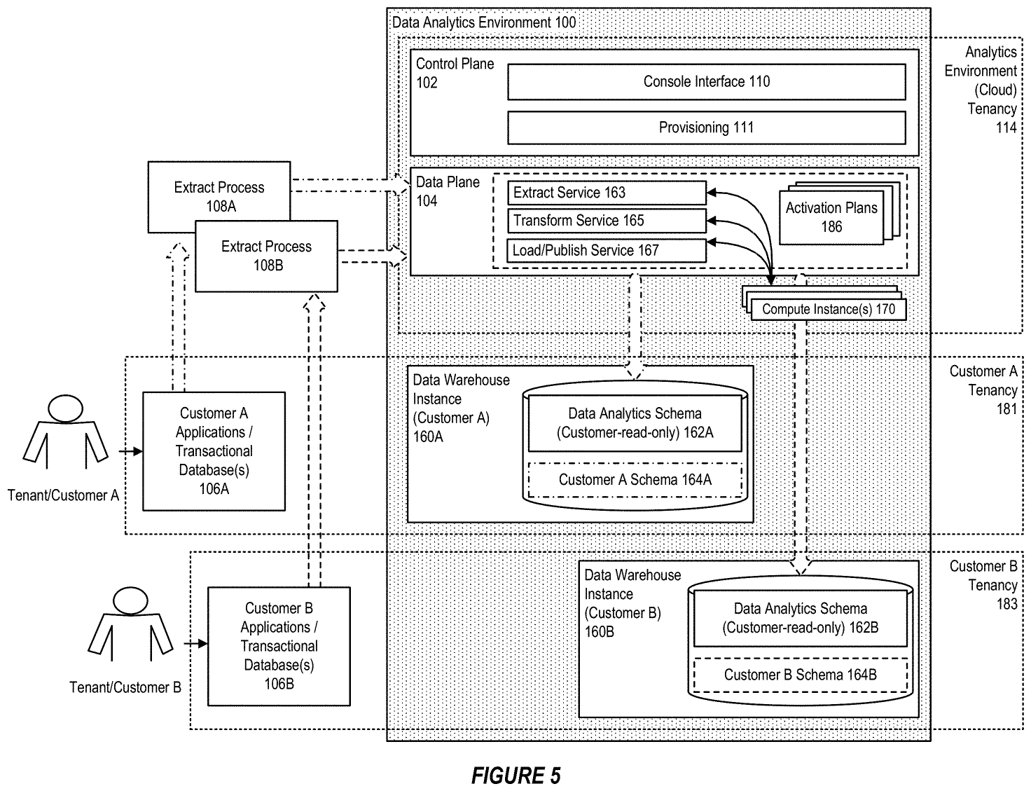

FIG. 5 further illustrates an example data analytics environment, in accordance with an embodiment.

As illustrated in FIG. 5, which illustrates the operation of the system with a plurality of tenants (customers) in accordance with an embodiment, data can be sourced, e.g., from each of a plurality of customer's (tenant's) enterprise software application or data environment, using the data pipeline process as described above; and loaded to a data warehouse instance.

In accordance with an embodiment, the data pipeline or process maintains, for each of a plurality of customers (tenants), for example customer A 180, customer B 182, a data analytics schema that is updated on a periodic basis, by the system in accordance with best practices for a particular analytics use case.

In accordance with an embodiment, for each of a plurality of customers (e.g., customers A, B), the system uses the data analytics schema 162A, 162B, that is maintained and updated by the system, to pre-populate a data warehouse instance for the customer, based on an analysis of the data within that customer's enterprise applications environment 106A, 106B, and within each customer's tenancy (e.g., customer A tenancy 181, customer B tenancy 183); so that data is retrieved, by the data pipeline or process, from the customer's environment, and loaded to the customer's data warehouse instance 160A, 160B.

In accordance with an embodiment, the data analytics environment also provides, for each of a plurality of customers of the environment, a customer schema (e.g., customer A schema 164A, customer B schema 164B) that is readily modifiable by the customer, and which allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to begin the transformation process, to transform the extracted data into a model format to be loaded into the customer schema of the data warehouse.

In accordance with an embodiment, activation plans 186 can be used to control the operation of the data pipeline or process services for a customer, for a particular functional area, to address that customer's (tenant's) particular needs.

For example, in accordance with an embodiment, an activation plan can define a number of extract, transform, and load (publish) services or steps to be run in a certain order, at a certain time of day, and within a certain window of time.

In accordance with an embodiment, each customer can be associated with their own activation plan(s). For example, an activation plan for a first Customer A can determine the tables to be retrieved from that customer's enterprise software application environment (e.g., their Fusion Applications environment), or determine how the services and their processes are to run in a sequence; while an activation plan for a second Customer B can likewise determine the tables to be retrieved from that customer's enterprise software application environment, or determine how the services and their processes are to run in a sequence.

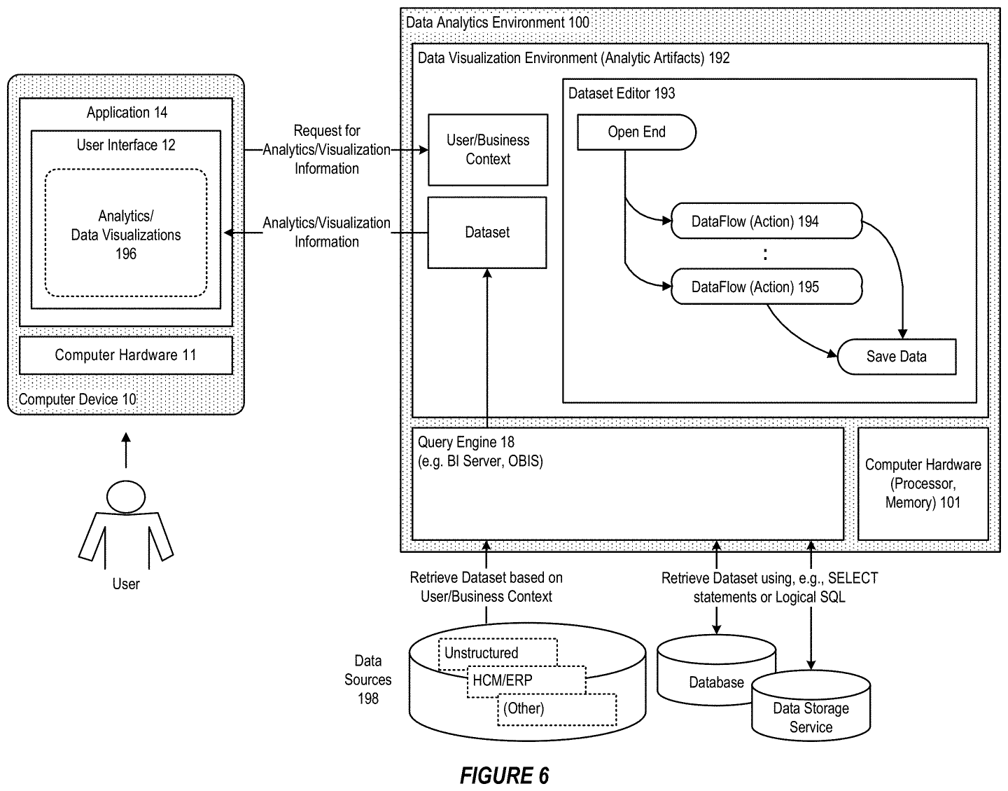

FIG. 6 illustrates a use of the system to transform, analyze, or visualize data, in accordance with an embodiment.

As illustrated in FIG. 6, in accordance with an embodiment, the systems and methods disclosed herein can be used to provide a data visualization environment 192 that enables insights for users of an analytics environment with regard to analytic artifacts and relationships among the same. A model can then be used to visualize relationships between such analytic artifacts via, e.g., a user interface, as a network chart or visualization of relationships and lineage between artifacts (e.g., User, Role, DV Project, Dataset, Connection, Dataflow, Sequence, ML Model, ML Script).

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the analytics system, or in the example of a cloud environment via a cloud service provided by the environment.

In accordance with an embodiment, the user interface can include or provide access to various dataflow action types, as described in further detail below, that enable self-service text analytics, including allowing a user to display a dataset, or interact with the user interface to transform, analyze, or visualize the data, for example to generate graphs, charts, or other types of data analytics or visualizations of dataflows.

In accordance with an embodiment, the analytics system enables a dataset to be retrieved, received, or prepared from one or more data source(s), for example via one or more data source connections. Examples of the types of data that can be transformed, analyzed, or visualized using the systems and methods described herein include HCM, HR, or ERP data, e-mail or text messages, or other of free-form or unstructured textual data provided at one or more of a database, data storage service, or other type of data repository or data source.

For example, in accordance with an embodiment, a request for data analytics or visualization information can be received via a client application and user interface as described above, and communicated to the analytics system (in the example of a cloud environment, via a cloud service). The system can retrieve an appropriate dataset to address the user/business context, for use in generating and returning the requested data analytics or visualization information to the client. For example, the data analytics system can retrieve a dataset using, e.g., SELECT statements or Logical SQL instructions.

In accordance with an embodiment, the system can create a model or dataflow that reflects an understanding of the dataflow or set of input data, by applying various algorithmic processes, to generate visualizations or other types of useful information associated with the data. The model or dataflow can be further modified within a dataset editor 193 by applying various processing or techniques to the dataflow or set of input data, including for example one or more dataflow actions 194, 195 or steps, that operate on the dataflow or set of input data. A user can interact with the system via a user interface, to control the use of dataflow actions to generate data analytics, data visualizations 196, or other types of useful information associated with the data.

In accordance with an embodiment, datasets are self-service data models that a user can build for data visualization and analysis requirements. A dataset contains data source connection information, tables, and columns, data enrichments and transformations. A user can use a dataset in multiple workbooks and in dataflows.

In accordance with an embodiment, when a user creates and builds a dataset, they can, for example: choose between many types of connections or spreadsheets; create datasets based on data from multiple tables in a database connection, an Oracle data source, or a local subject area; or create datasets based on data from tables in different connections and subject areas.

For example, in accordance with an embodiment, a user can build a dataset that includes tables from an Autonomous Data Warehouse connection, tables from a Spark connection, and tables from a local subject area; specify joins between tables; and transform and enrich the columns in the dataset.

In accordance with an embodiment, additional artifacts, features, and operations associated with datasets can include, for example:

View available connections: a dataset uses one or more connections to data sources to access and supply data for analysis and visualization. A user list of connections contains the connections that they built and the connections that they have permission to access and use.

Create a dataset from a connection: when a user creates a dataset, they can add tables from one or more data source connections, add joins, and enrich data.

Add multiple connections to a dataset: a dataset can include more than one connection. Adding more connections allows a user to access and join all of the tables and data that they need to build the dataset. The user can add more connections to datasets that support multiple tables.

Create dataset table joins: joins indicate relationships between a dataset's tables. If the user is creating a dataset based on facts and dimensions and if joins already exist in the source tables, then joins are automatically created in the dataset. If the user is creating a dataset from multiple connections and schemas, then they can manually define the joins between tables.

In accordance with an embodiment, a user can use dataflows to create datasets by combining, organizing, and integrating data. Dataflows enable the user to organize and integrate data to produce curated datasets that either they or other users can visualize.

For example, in accordance with an embodiment, a user might use a dataflow to: Create a dataset; Combine data from different source; aggregate data; and train a machine learning model or apply a predictive machine learning model to their data.

In accordance with an embodiment, a dataset editor as described above allows a user to add actions or steps, wherein each step performs a specific function, for example, add data, join tables, merge columns, transform data, or save the data. Each step is validated when the user adds or changes it. When they have configured the dataflow, they can execute it to produce or update a dataset.

In accordance with an embodiment, a user can curate data from datasets, subject areas, or database connections. The user can execute dataflows individually or in a sequence. The user can include multiple data sources in a dataflow and specify how to join them. The user can save the output data from a dataflow in either a dataset or in a supported database type.

In accordance with an embodiment, additional artifacts, features, and operations associated with dataflows can include, for example:

Add columns: add custom columns to a target dataset.

Add data: add data sources to a dataflow. For example, if the user is merging two datasets, they add both datasets to the dataflow.

Aggregate: create group totals by applying aggregate functions; for example, count, sum, or average.

Branch: creates multiple outputs from a dataflow.

Filter: select only the data that the user is interested in.

Join: combine data from multiple data sources using a database join based on a common column.

Graph Analytics: perform geo-spatial analysis, such as calculating the distance or the number of hops between two vertices.

The above are provided by way of example; in accordance with an embodiment other types of steps can be added to a dataflow to transform a dataset or provide data analytics or visualizations.

### Dataset Analyses and Visualizations

In accordance with an embodiment, the system provides functionality that allows a user to generate datasets, analyses, or visualizations for display within a user interface, for example to explore datasets or data sourced from multiple data sources.

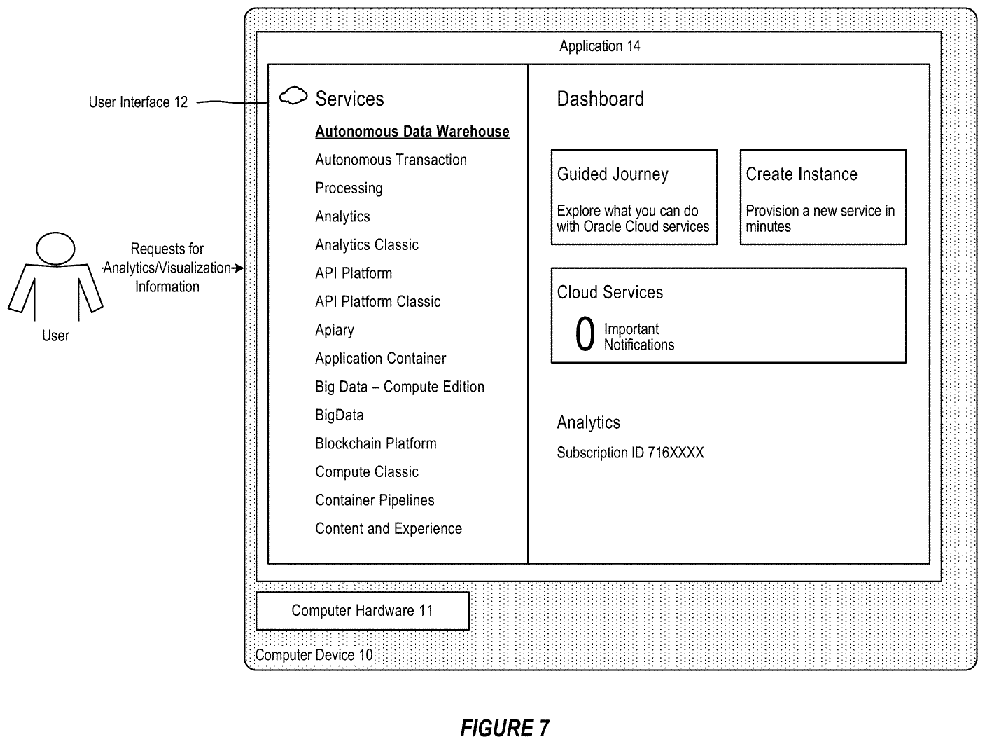

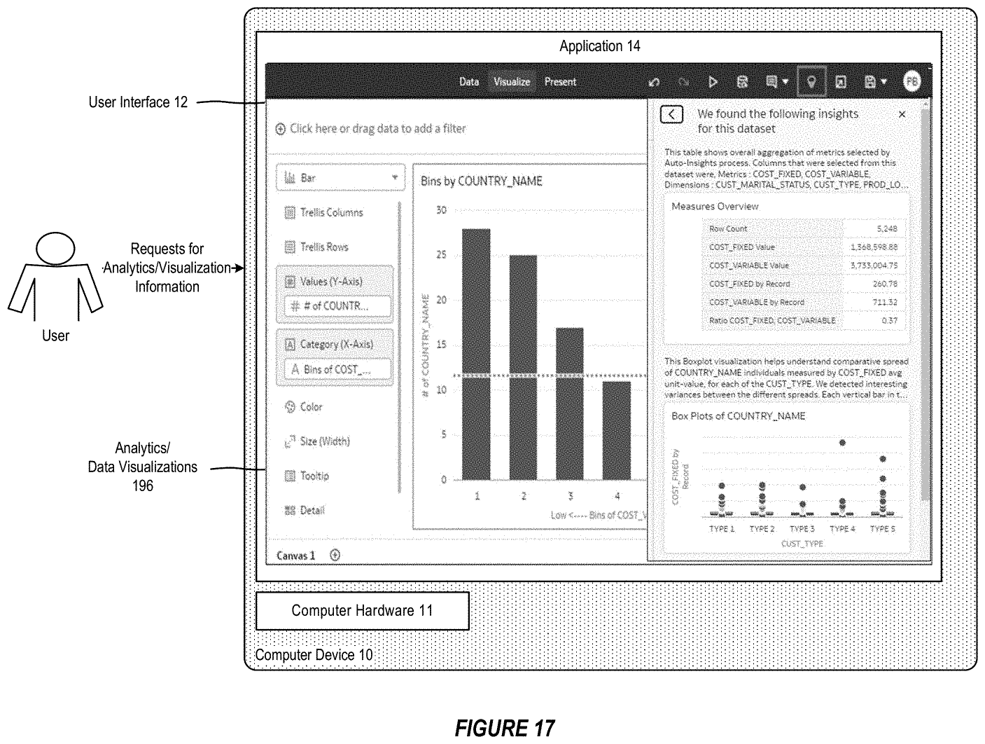

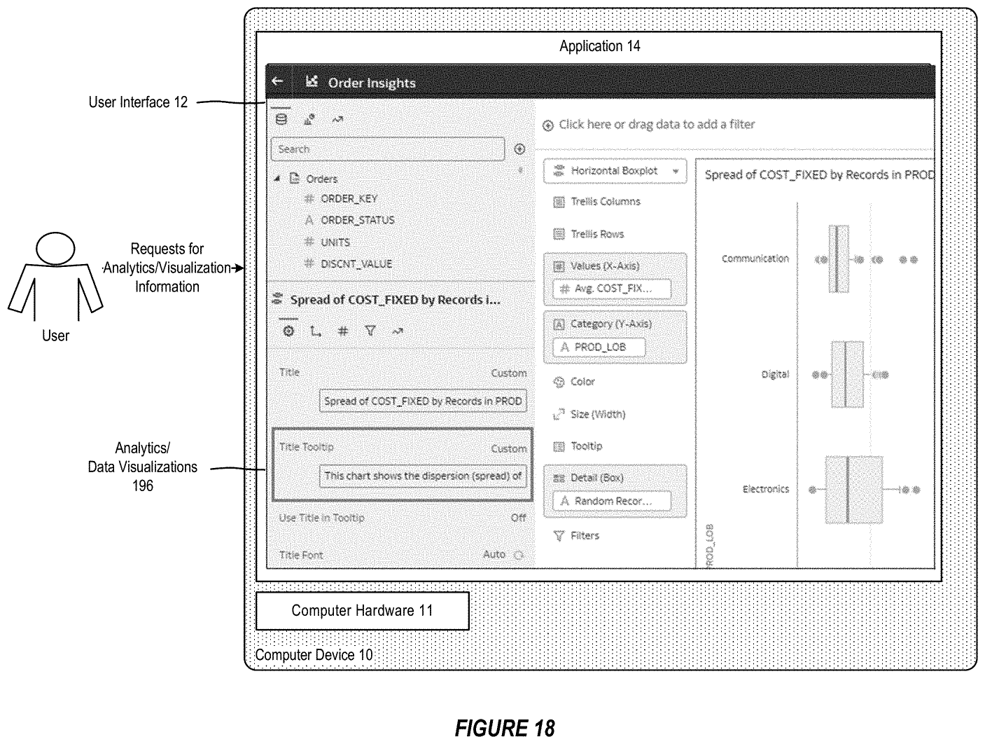

FIGS. 7-18 illustrate various examples of user interfaces for use with a data analytics environment, in accordance with an embodiment.

The user interfaces and features shown in FIGS. 7-18 are provided by way of example, for purposes of illustration of the various features described herein; in accordance with various embodiments, alternative examples of user interfaces and features can be provided.

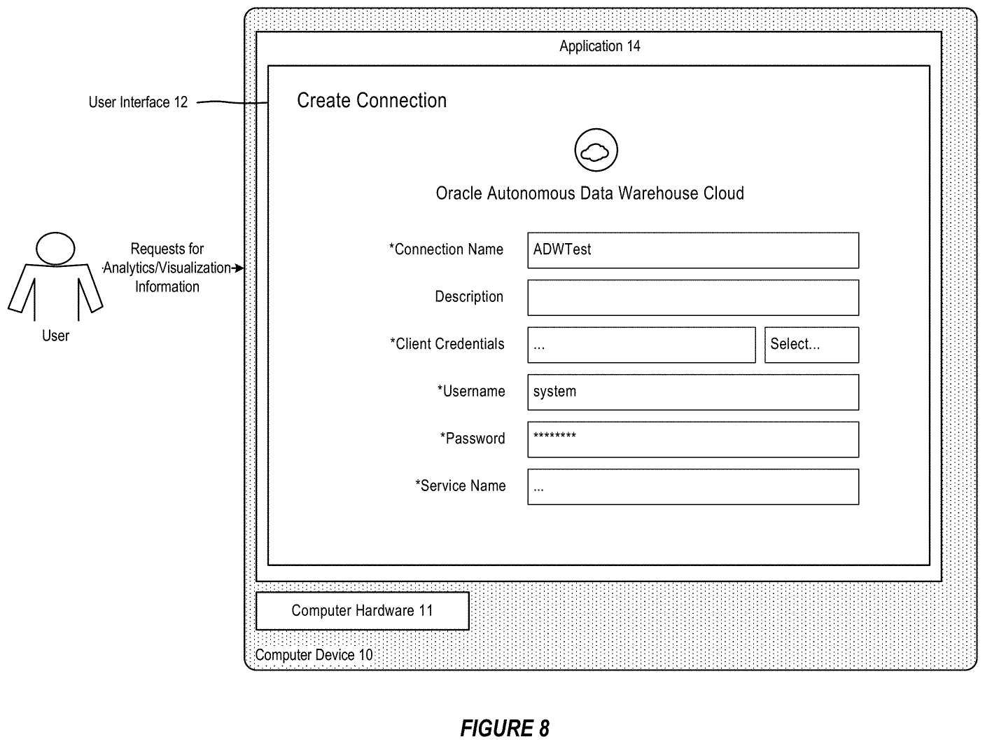

As illustrated in FIGS. 7-8, in accordance with an embodiment, the user can access the data analytics environment, for example to submit analyses or queries against an organization's data.

For example, in accordance with an embodiment, the user can choose between various types of connections to create datasets based on data from tables in, e.g., a database connection, an Oracle subject area, an Oracle ADW connection, or a spreadsheet, file, or other type of data source. In this manner, a dataset operates as a self-service data model from which the user can build a data analysis or visualization.

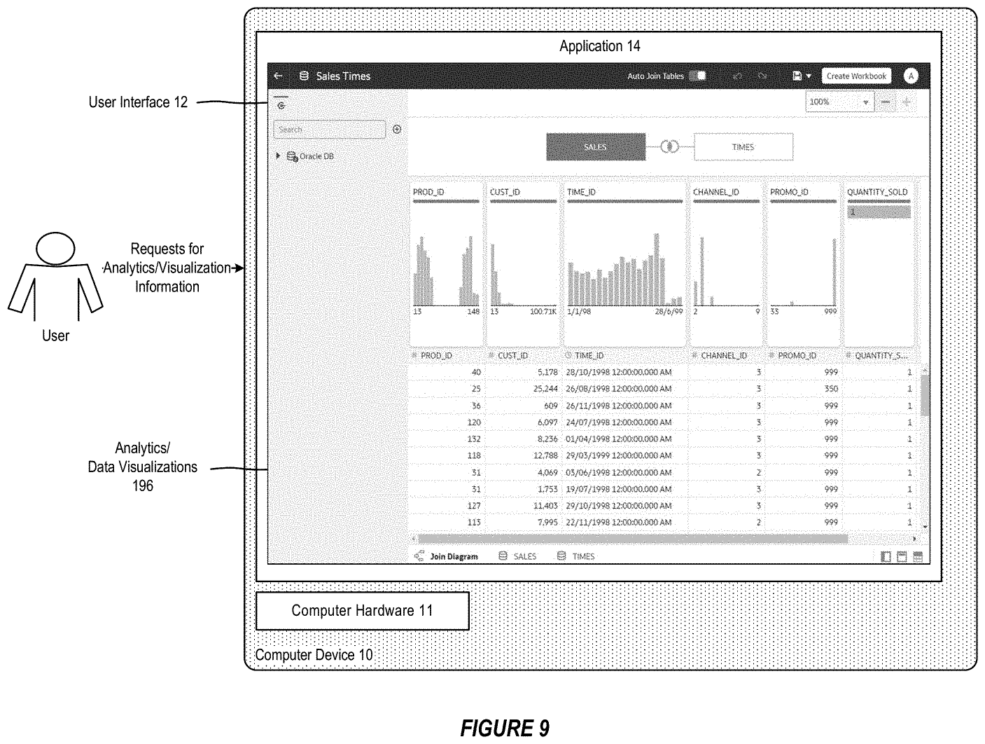

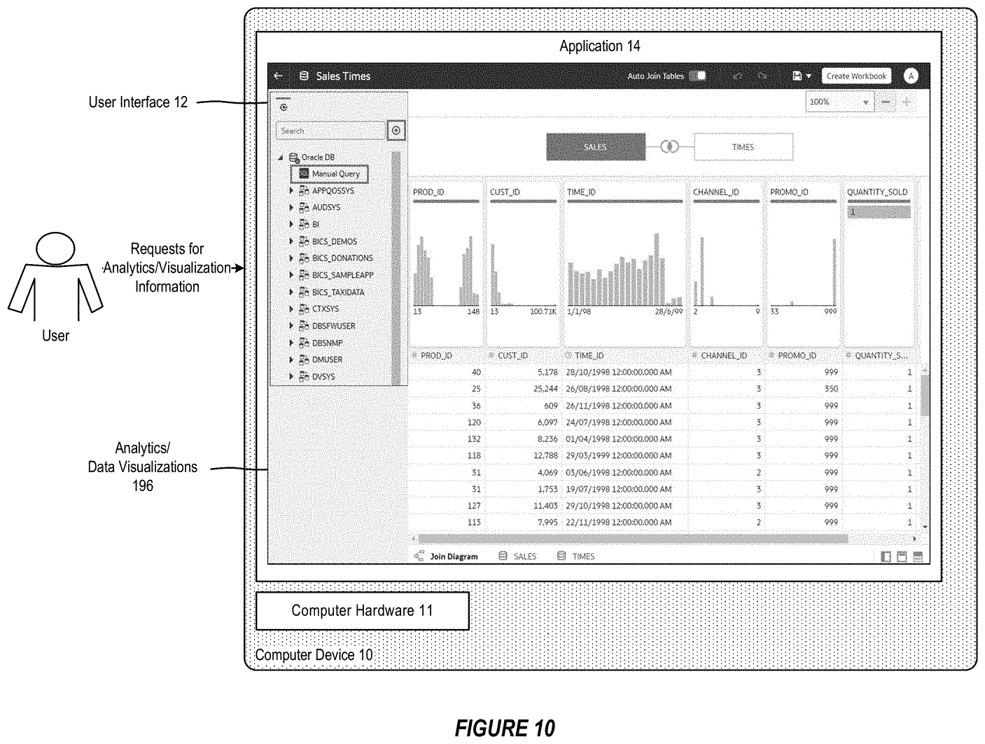

As illustrated in FIGS. 9-10, in accordance with an embodiment, a dataset editor can display a list of connections which the user has permission to access, and allow the user to create or edit a dataset that includes tables, joins, and/or enriched data. The editor can display the data source connection's schemas and tables, from which the user can drag and drop to a dataset diagram. If a particular connection does not itself provide a schema and table listing the user can use a manual query for appropriate tables. Adding connections provide the ability to access and join their associated tables and data, to build the dataset.

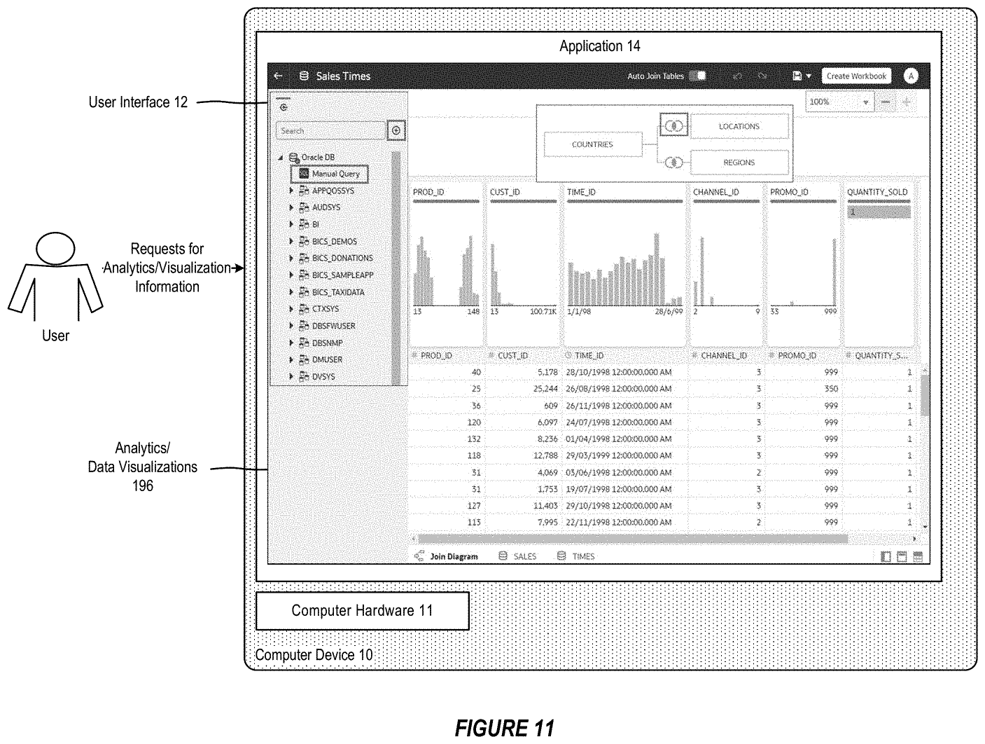

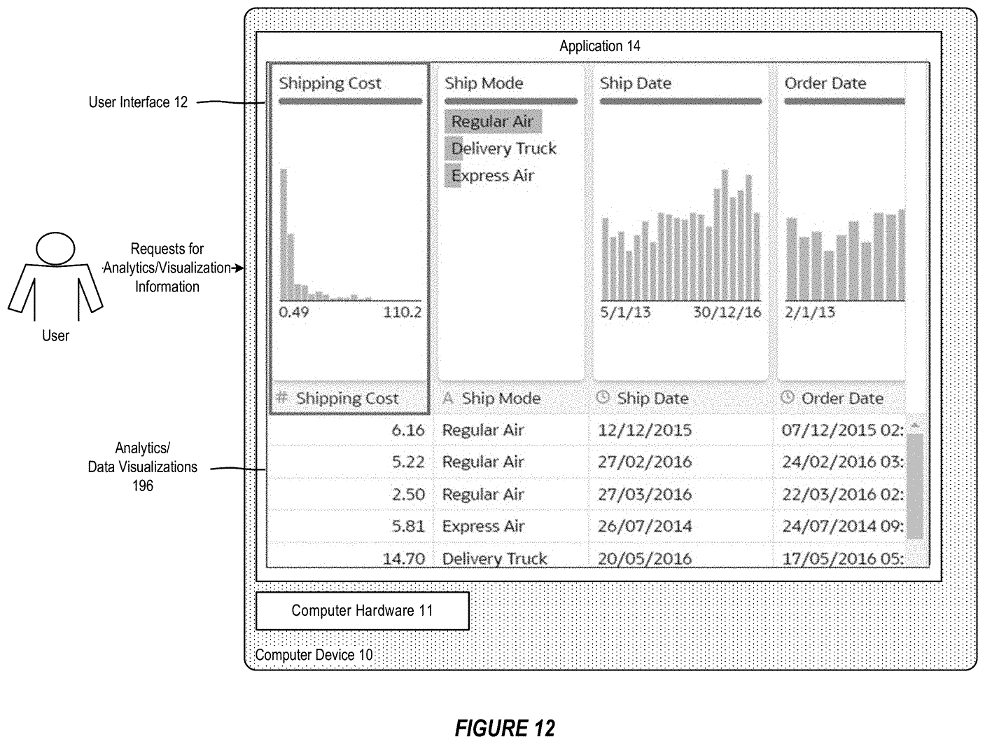

As illustrated in FIGS. 11-12, in accordance with an embodiment, within the dataset editor a join diagram displays the tables and joins in a dataset. Joins that are defined in the data source can be automatically created between tables in the dataset, for example, by creating joins based on column name matches found between the tables.

In accordance with an embodiment, when the user selects a table, a preview data area displays a sample of the table's data. Displayed join links and icons indicate which tables are joined and the type of join used. The user can create a join by dragging and dropping one table onto another; click on a join to view or update its configuration; or click a column's type attribute to change its type, for example from a measure to an attribute.

In accordance with an embodiment, the system can generate source-specific optimized queries for a visualization, wherein a dataset is treated as a data model and only those tables needed to satisfy a visualization are used in the query.

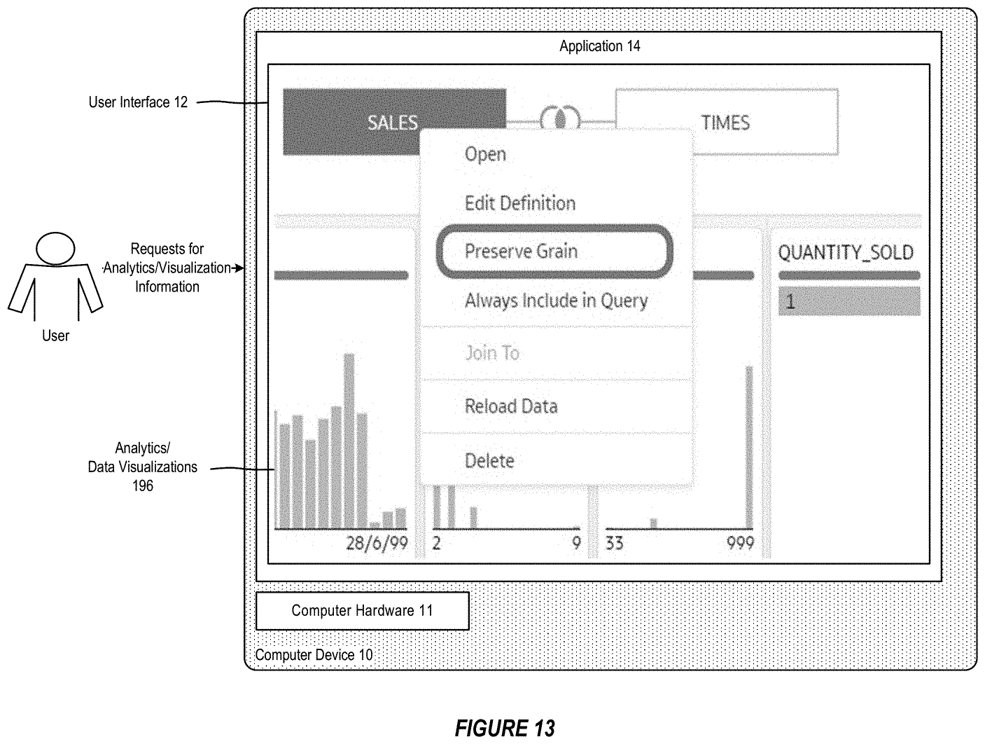

By default a dataset's grain is determined by the table with the lowest grain. The user can create a measure in any table in a dataset; however, this can cause the measure on one side of a one-to-many or many-to-many relationship to be duplicated. In accordance with an embodiment illustrated in FIG. 13, to address this, the user can set the table on one side of a cardinality to preserve grain, to keep its level of detail.

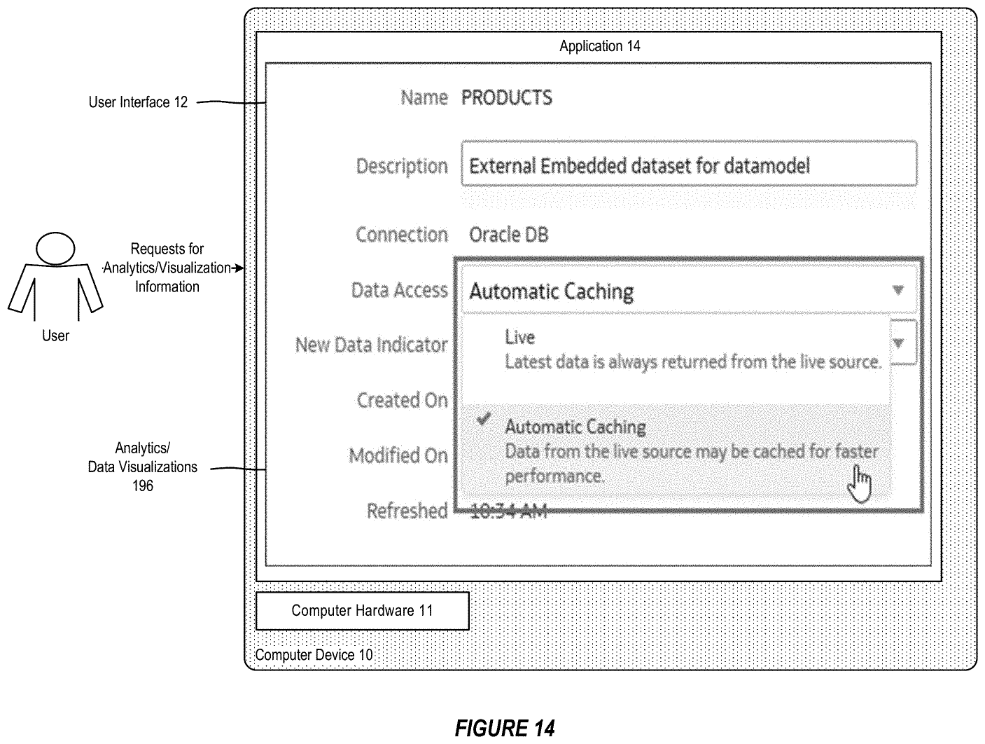

As illustrated in FIG. 14, in accordance with an embodiment, dataset tables can be associated with a data access setting that determines if the system will load the table into cache, or alternatively if the table will receive its data directly from the data source.

In accordance with an embodiment, when automatic caching mode is selected for a table, the system loads or reloads the table data into cache, which provides faster performance when the table's data is refreshed, e.g., from a workbook, and causes the reload menu option to display at the table and dataset level.

In accordance with an embodiment, when live mode is selected for a table, the system retrieves the table data directly from the data source; and the source system manages the table's data source queries. This option is useful when the data is stored in a high-performance data warehouse such as, for example, Oracle ADW; and also ensures that the most-current data is used.

In accordance with an embodiment, when a dataset uses multiple tables, some tables can use automatic caching, while others can include live data. During reload of multiple tables using the same connection, if the reloading of data on one table fails, then any tables presently set to use automatic caching are switched to using live mode to retrieve their data.

In accordance with an embodiment, the system allows a user to enrich and transform their data before it is made available for analysis. When a workbook is created and a dataset added to it, the system performs column level profiling on a representative sample of the data. After profiling the data, the user can implement transformation and enrichment recommendations provided for recognizable columns in the dataset; such as, for example, GPS enrichments such as latitude and longitude for cities or zip codes.

In accordance with an embodiment, the data transformation and enrichment changes applied to a dataset affect the workbooks and dataflows that use the dataset. For example, when the user opens a workbook that shares the dataset, they receive a message indicating that the workbook uses updated or refreshed data.

In accordance with an embodiment, dataflows provide a means of organizing and integrating data to produce curated datasets that your users can visualize. For example, the user might use a dataflow to create a dataset, combine data from different sources, aggregate data, or train machine learning models or apply a predictive machine learning model to their data.

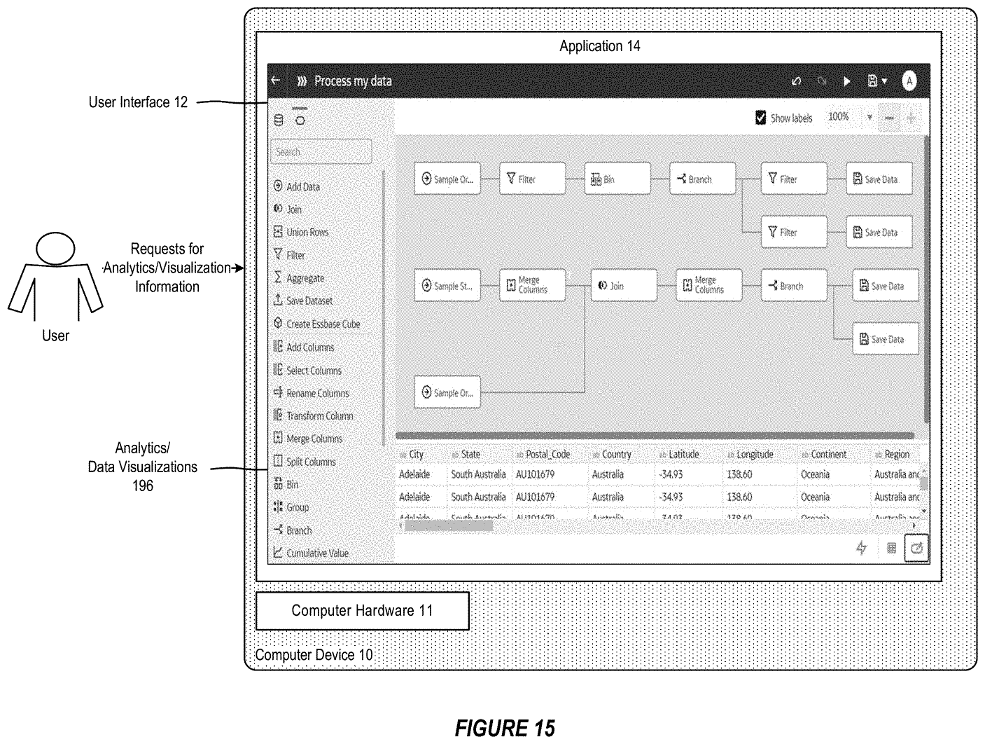

As illustrated in FIG. 15, in accordance with an embodiment, within a dataflow each step performs a specific function, for example to add data, join tables, merge columns, transform data, or save data. Once configured, the dataflow can be executed to perform operations to produce or update a dataset, including for example the use of SQL operators, such as BETWEEN, LIKE, IN), conditional expressions, or functions.

In accordance with an embodiment, dataflows can be use merge datasets, cleanse data, and output the results to a new dataset. Dataflows can be executed individually or in a sequence. If any dataflow within a sequence fails, then all the changes made in the sequence are rolled back.

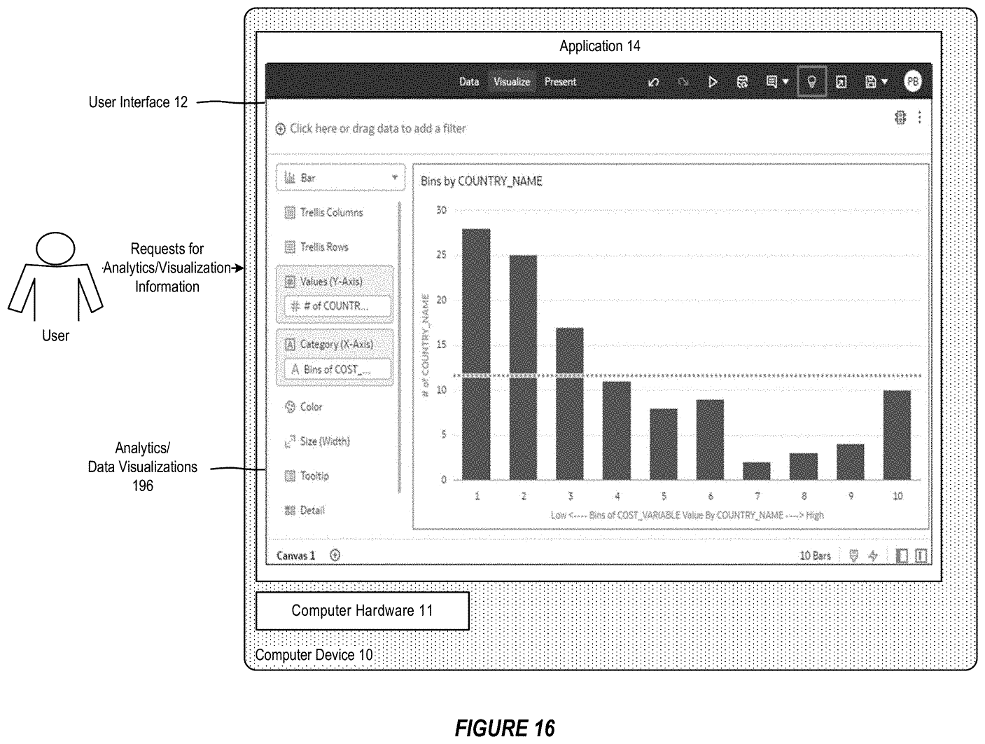

As illustrated in FIGS. 16-18, in accordance with an embodiment, visualizations can be displayed within a user interface, for example to explore datasets or data sourced from multiple data sources, and to add insights.

For example, in accordance with an embodiment, the user can create a workbook, add a dataset, and then drag and drop its columns onto a canvas to create visualizations. The system can automatically generate a visualization based on the contents of the canvas, with one or more visualization types automatically selected for selection by the user. For example, if the user adds a revenue measure to the canvas, the data element may be placed in a values area of a grammar panel, and a Tile visualization type selected. The user can continue adding data elements directly to the canvas to build the visualization.

In accordance with an embodiment, the system can provide automatically generated data visualizations (automatically-generated insights, auto-insights), by suggesting visualizations which are expected to provide the best insights for a particular dataset. The user can review an insight's automatically generated summary, for example by hovering over the associated visualization in the workbook canvas.

### Automatic Insights

In accordance with an embodiment, the systems and methods disclosed herein provide an easy-to-use method of building data visualizations (also referred to herein as “visualizations” or “vizs”) for data sets that are connected to an analytics environment. For example, upon uploading or connecting a previously uploaded data set to an analytics environment (such as Oracle Analytics Cloud discussed above), the systems and methods can automatically provide a plurality of data visualizations for a user to, e.g., select from or pick and choose to drag into an analytics pane of a user interface.

In accordance with an embodiment, the systems and methods described herein can, based upon a provided data set (e.g., an uploaded data set or a data set already existing within an analytics environment), analyze the data sets (e.g., columns therein) to identify key columns that can be displayed within data visualizations. Upon such an analysis, the systems and methods can further provide, e.g., via a user interface, a number of selected data visualizations for selection by, e.g., a user of the analytics environment.

In accordance with an embodiment, such systems and methods have an upside of automatically providing for selection and analysis a number of highly descriptive and desirable data visualizations that are beneficial to an end user.

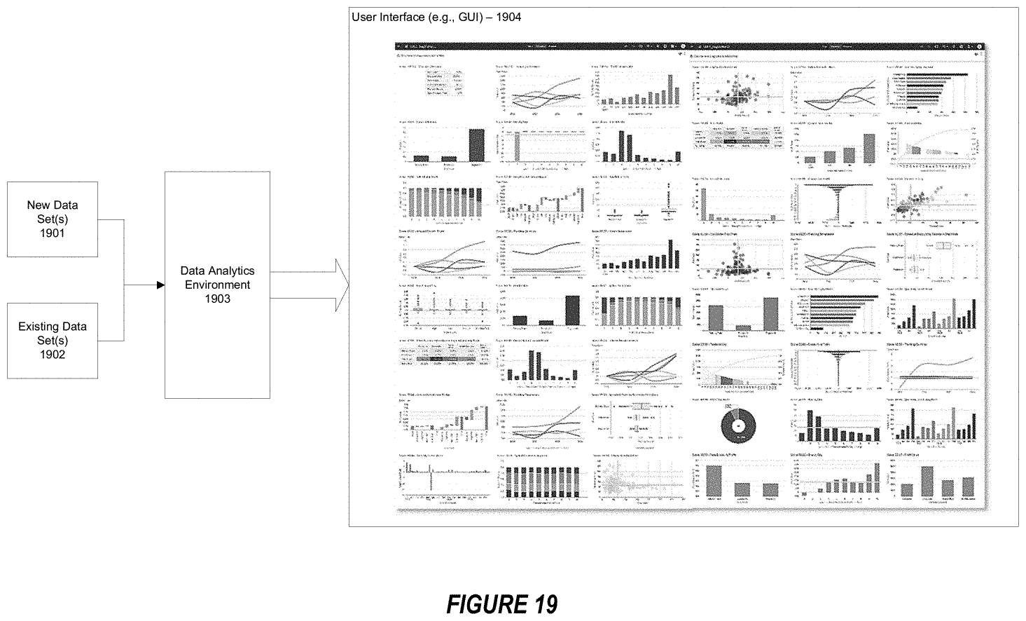

FIG. 19 is a diagram of an overall flow of an automatic insights feature, in accordance with an embodiment.

FIG. 19 shows data sets, such as a CSV or EXCEL file, or previously uploaded data at a database being imported into an analytics cloud data store. From such connection to a data set, a number of data visualizations can be automatically presented to a user via, e.g., a user interface.

More specifically, in accordance with an embodiment, one or more data sets, 1901 and 1902, can be connected to the data analytics environment 1903, as discussed above. These data sets can comprise any number of data formats, including, but not limited to, CSV, EXCEL, or other filetypes or formats. Such data sets can be newly uploaded (e.g., by a user or via automatic/scheduled upload), or can already be existing within the data analytics environment via a linked database.

In accordance with an embodiment, the data analytics environment can, based upon an analysis of the linked data, display a number data visualizations via a user interface 1904, e.g., a graphical user interface. Such data visualizations can comprise a selectable format in which inputs can be received indicative of a desired data visualization to be selected, e.g., for display and/or analysis.

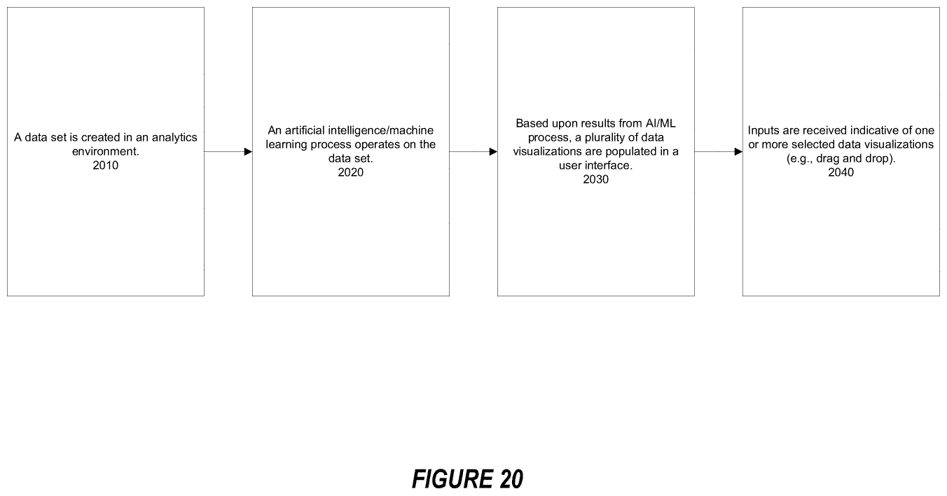

FIG. 20 is a flowchart of a user experience of an automatic insights feature, in accordance with an embodiment.

In accordance with an embodiment, from a user perspective, once a user creates or attaches a data set to an analytics environment 2010, such as OAC, an artificial intelligence/machine learning process can introspect the data set 2020, and from such introspection, provide a user with a view (canvas) of optional data visualizations 2030. The user can then choose/select which visualizations to be brought into a workspace of the user interface 2040.

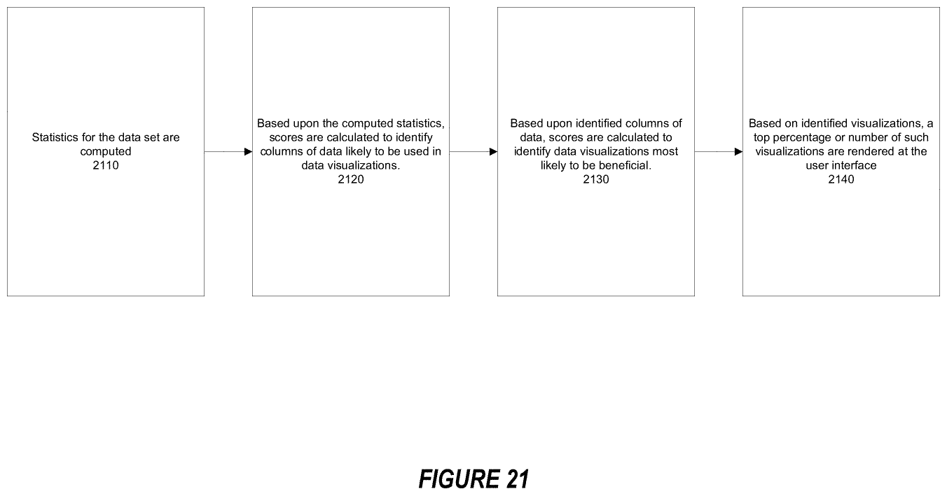

FIG. 21 is a flowchart for an automatic insights feature, in accordance with an embodiment.

In accordance with an embodiment, the systems and methods can compute various statistics associated with a stored, linked, or uploaded data set 2110. The systems and methods can then utilize one or more scoring mechanisms or rules to identify a set of columns of data (or rows depending upon how the data set is configured—however, for the remainder of the description, the term “column” will be used for ease of reference) that are determined to score the highest for data visualization insights (e.g., columns of data that are not sparse, columns of data that comprise relationships with other columns of data, etc.) 2120. In addition, during this scoring phase, computations between two or more columns of data can be generated and scored as well (e.g., ratios between costs/profits, ratios between total sales and number of employees, etc.).

In accordance with an embodiment, the systems and methods can then, based upon a number N of columns that are identified at step 2120 as having particular importance, or a high likelihood of usefulness within a data visualization, a number M of data visualizations are generated and then scored to select a set Y of the M data visualizations that have a high probability of displaying meaningful data visualizations 2130.

In accordance with an embodiment, the systems and methods can then render a set of top-scoring data visualizations for presentation via a user interface 2140.

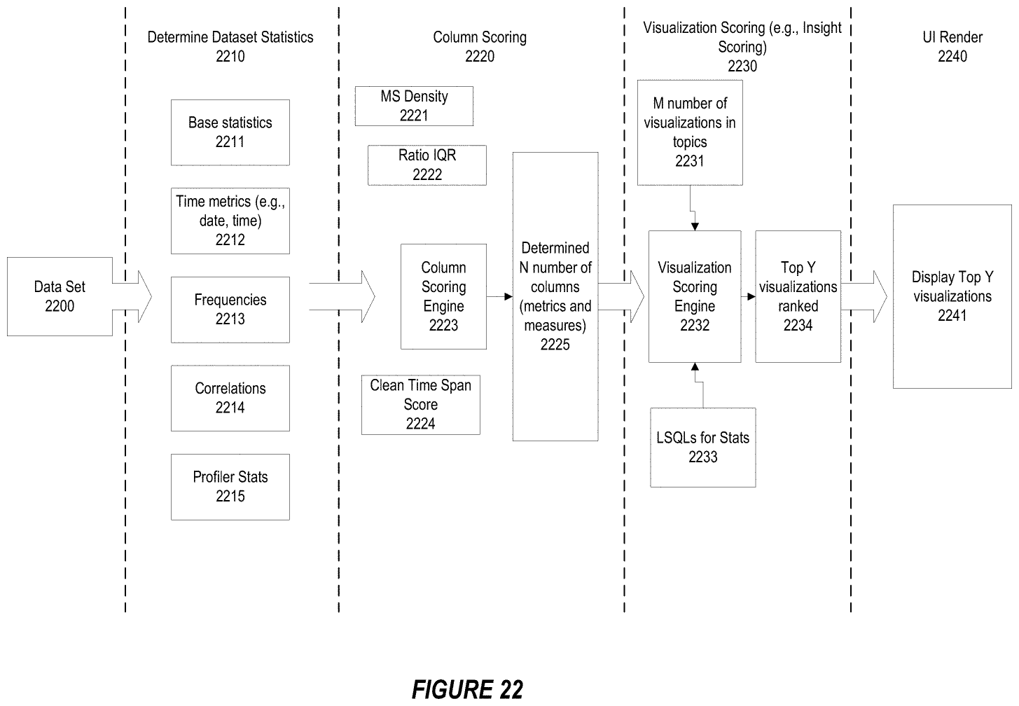

FIG. 22 is a flowchart for an automatic insights feature, in accordance with an embodiment.

In accordance with an embodiment, a data set 2200 can be uploaded, linked, or otherwise accessed by an analytics environment. From this data set, various statistics of the data set can be computed 2210. These can include, for example, base statistics 2211, date and/or time statistics, such as time metrics 2212, frequency statistics 2213, correlations between columns 2214 (e.g., computing a profit margin by dividing profit by revenue, etc.), and profiler statistics 2215. These dataset statistics are then utilized in a column scoring 2220 (e.g., scores that are calculated for column scoring, which can be referred to as column scores or a column score).

In accordance with an embodiment, the score generated for each column of the plurality of columns can be based upon a utilization of a configurable set of rules that operate on each set of statistics for each of the plurality of columns of the data set.

In accordance with an embodiment, from these statistics, the systems and methods can move on to scoring the columns via a columns rules scoring engine.

In accordance with an embodiment, the columns rules scoring engine 2223 can, on being given a data set and statistics associated therewith, calculate distribution stats on the columns of the data set 2200. Using the distribution stats, the systems and methods can identify which columns are, for example, dense and representative of the data set 2225. The systems and methods do this for a set of columns, dimensions and metrics. As well, the systems and methods can take into account time fields and pick a date around which to trend data of the data set. This time field can be determined in order determine which time field(s) is most useful for data visualizations. The systems and methods generate from this step a set/series of columns, generally smaller than the original number of columns within the data set. The systems and methods not only extract columns, but can also build ratios between columns—e.g., extracting cost and sales from data set, then automatically do a ratio of cost and sales and present that in a visualization, if such a calculated column scores well, such as ratios, indexes, and normalized data.

In accordance with an embodiment, below is a chart showing exemplary column scoring rules, e.g., for columns have medium cardinality:

TABLE 1

| Rule | Value | Score | Comment |
|---|---|---|---|
| Select Column | A column within the dataset | 500 | Column needs to be |
| | with “_insights” in the | | selected for data |
| | column name | | visualizations |
| User | User interested in column | 50 | When changes are |
| Interested | | | made to a column of |
| | | | data, column is |
| | | | marked as user |
| | | | interested |
| Null % | <=1% | 100 | Columns with high |
| | 1% < Null % <= 5% | 90 | density are more |
| | 5% < Null % <= 10% | 80 | favored |
| | 10% < Null % <= 15% | 70 | |
| | 15% < Null % <= 25% | 60 | |
| | 25% < Null % <= 50% | 50 | |
| | 50% < Null % <= 60% | 40 | |
| Cardinality | All columns with cardinality | 0.5 × Cardinality | For example, |
| | between 15 to 200 | | Cardinality = 102 |
| | | | provides a score of |
| | | | 51 |
| Null Penalty | Penalty for NULL % | −0.1 × NULL % | Penalty for NULL |
| | | | percentage. This |
| | | | helps in tie-breaking |
| | | | equally scored |
| | | | columns |
| Integer | Penalty for Integer and | Integer = −30 | |
| | Decimal Values | Decimal = −300 | |
| Key Words | Columns with certain | −25 (percent) | |
| | keywords are scored lower | −50 (Special - ID) | |
| | | −100 (Lat-Long) | |
| | | −500 (Time columns) | |
| Text Length | TL Average >= 35 | −10 | Favor columns with |
| | 27 >= TL Avg < 35 | 0 | good Text Length |
| | 20 >= TL Avg < 27 | 6 | Average (can be a |
| | 15 >= TL Avg < 20 | 8 | tie-breaker rule) |
| | 10 >= TL Avg < 15 | 12 | |
| | 7 >= TL Avg < 10 | 15 | |
| | 5 >= TL Avg < 7 | 9 | |
| | 4 >= TL Avg < 5 | 5 | |
| | 3 >= TL Avg < 4 | 2 | |
| | Default | −100 | |

In accordance with an embodiment, as shown above in Table 1, various rules can be utilized to score the columns of data. These rules include, but are not limited to, a column selection, a user interest flag, a null percentage, cardinality, a null penalty, integer, key words, and text length.

In accordance with an embodiment, the systems and methods can score the columns of data according to, for example, the following measures:
User Interested—when making changes to column, the column is marked user interested
Null percentage—score increase high density columns
Cardinality/Boolean—score increase columns with Right Cardinality
Decimal—score decrease for Decimal Values
Null Penalty—score decrease for high NULL percentage
Integer—score decrease for Integer Values
Key Words—Columns with certain Keywords are scored Lower
Text Length—score increase for columns with proper Text Length Average
Frequency—score decrease for having a low frequency (Item members)
Metrics:
   Unicity—score increase for high Unicity
   Skewness—score increase Normal bell shapes
   Kurtosis—score increase skewed metrics
   Key Words—Time/IDs Percent, Average, Ranking
   Metric Density—score increase Dense metrics
   Metrics ID—ID Like Columns are Scored Low
   IQR—Averages and Ratios Scored Low
   Attribute Conflict—Profile Identified the Column as Attrib
   Cardinality Tie Break—Low Cardinality Columns' Tie Breaker
   Negative Penalty—Negative Columns are Scored Lower
   Lat Long Score

In accordance with an embodiment, while the above rules in Table 1 can apply to columns within the data set having medium cardinality, other rule sets can be provided for all columns of data within a data set such that each column of data in the data set is scored. Scoring data columns can also involve MS density 2221, ration IQR 2222 and clean time span score 2224.

In accordance with an embodiment, the systems and methods can then score the columns of data within the data set and select a set of N columns of data (metrics and measures) of most meaningful for use in visualization scoring 2230 (e.g., scores that are calculated for visualization scoring, which can be referred to as visualization scores or a visualization score).

In accordance with an embodiment, on being passed the scored and selected N number of columns of data from the data set, the systems and methods can generate, based upon sets of rules, M number of data visualizations 2231 based on the N number of columns of data. These rules can comprise rules for, example, determining which types of data visualizations to utilize, for example, for various types of data columns. For example, this rule set can comprise rules for selecting which types of data visualization to be utilized depending on various computed statistics of the columns of data (e.g., selecting a bar graph visualization for certain of the N columns of data, while selecting scatter plots for certain other of the N number columns of data).

In accordance with an embodiment, while discussed as the N number of columns of data, it should be noted here that this N number of columns of data does not necessarily correlate to direct columns of data from the data set 2200, such as where ratios were computed between columns of data.

In accordance with an embodiment, in generating these M number of data visualizations based upon the determined N number of columns of data, structured language query (LSQLs) 2223 can be utilized to pull the requested data from the data set. In addition, when generating these M number of data visualizations, the systems and methods can additionally perform operations on the columns of data in order to produce potentially more valuable data visualizations. These operations can include, for example, calculation ratios between columns of data, normalizing data, or indexing data.

In accordance with an embodiment, once the M number of data visualizations have been generated, a data visualization scoring engine 2232 can be utilized to score each of the generated M number of data visualizations. For each type of data visualization (e.g., bar graph, scatter plot, pie graph, line graph), certain or all rules can be utilized to generate a score for each of the M data visualizations. For example, scoring can be based on variability within each generated data visualization. Data visualizations showing outliers, distinct trends (e.g., slopes on line graphs), and generally data visualizations that exhibit greater visual contrast (e.g., data visualizations that are considered more beneficial to a user of the system, for example, due to displays to data displaying, visually, high contrast between plotted data) can be scored higher than those that do not.

In accordance with an embodiment, for example, for a scatter plot, the systems and methods can utilize a dispersion analysis (the average distance from each point to a trend line fitted to the data points on the scatter plot). A scatter plot of columns of the data set having a higher dispersion analysis score (meaning it has more points further away from the fitted trend line) will score higher than a scatter plot of other columns of the data set that have a lower dispersion analysis score (meaning a plot having a tight grouping of data points).

In accordance with an embodiment, in scoring the M number of visualizations, certain factors can be considered to determine how the M visualizations are to be scored by the scoring engine 2232. These include, for example, high contrast, evident trend line. Data visualizations showing contrast in data plots or data points is generally better/more beneficial/more interesting to a user than data visualizations that show less contrast (e.g., data visualizations showing flat lines). For example, a data visualization that relies on a dense time level can plot a number of trending charts associated therewith. Then, when looking for trending data in data visualizations, the systems and methods can display charts that have an evident trend line.

In accordance with an embodiment, once the systems and methods scored the M number of visualizations, a top Y (highest scoring) number of visualizations 2234 are selected from the M number of produced visualizations and displayed via a user interface rendering 2240 to be displayed 2241 in a selectable manner at the user interface. a finite number of visualizations.

In accordance with an embodiment, while the top Y visualizations are displayed via the user interface, the systems and methods can continue to track other high scoring of the M number of visualizations such that if any or all of the top Y visualizations are dismissed or discarded via the user interface, then the systems and methods can continue to display a next highest scoring of the M number of visualizations via the user interface.

In accordance with an embodiment, the above description utilizes certain integer numbers, such as N number of top data columns from the data set to be utilized in generating M number of top visualizations in topics, from which a number Y visualizations are scored the highest. These integer values can be automatically set by the systems and methods of the data analytics environment, or they can be set by a user of such an environment. Exemplary values for these are N=10 columns of (metrics and measures), 250 number of visualizations in topics, and the top 10 visualizations for these 250 visualizations.

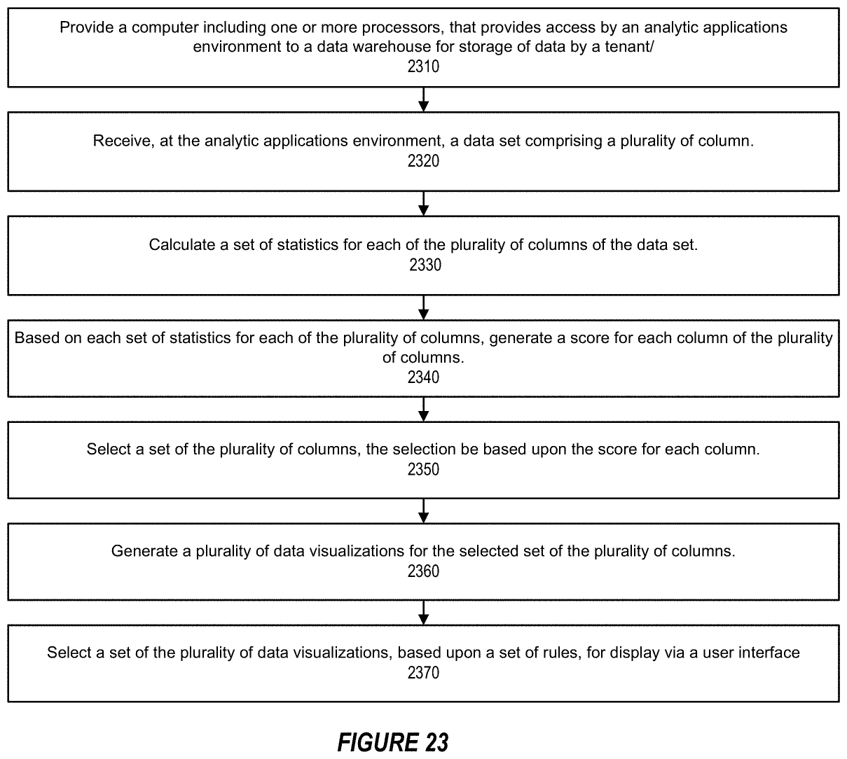

FIG. 23 is a flowchart of a method for generating automatic insights of analytics data, in accordance with an embodiment.

In accordance with an embodiment, at step 2310, the method can provide a computer including one or more processors, that provides access by an analytic applications environment to a data warehouse for storage of data by a tenant.

In accordance with an embodiment, at step 2320, the method can receive, at the analytic applications environment, a data set comprising a plurality of columns.

In accordance with an embodiment, at step 2330, the method can calculate a set of statistics for each of the plurality of columns of the data set.

In accordance with an embodiment, at step 2340, the method can, based on each set of statistics for each of the plurality of columns, generate a score for each column of the plurality of columns.

In accordance with an embodiment, at step 2350, the method can select a set of the plurality of columns, the selection be based upon the score for each column.

In accordance with an embodiment, at step 2360, the method can generate a plurality of data visualizations for the selected set of the plurality of columns.

In accordance with an embodiment, at step 2370, the method can select a set of the plurality of data visualizations, based upon a set of rules, for display via a user interface.

In accordance with an embodiment, the score generated for each column of the plurality of columns can utilize a configurable set of rules that operate on each set of statistics for each of the plurality of columns of the data set.

In accordance with an embodiment, the set of rules utilized to select the plurality of data visualizations for display via the user interface can comprise rules that score data visualizations with high visual contrast higher that data visualizations with low visual contrast.

In accordance with various embodiments, the teachings herein may be conveniently implemented using one or more conventional general purpose or specialized computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, or other electromechanical data storage devices, floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art.

For example, although several of the examples provided herein illustrate operation of an analytic applications environment with an enterprise software application or data environment such as, for example, an Oracle Fusion Applications environment; or within the context of a software-as-a-service (SaaS) or cloud environment such as, for example, an Oracle Analytics Cloud or Oracle Cloud Infrastructure environment; in accordance with various embodiments, the systems and methods described herein can be used with other types of enterprise software application or data environments, cloud environments, cloud services, cloud computing, or other computing environments.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

What is claimed is:

1. A system for generating automatic insights of analytics data, comprising:
a computer including one or more processors, that provides access by an analytic applications environment to a data warehouse for storage of data by a tenant;
wherein the computer receives, at the analytic applications environment, a data set comprising a plurality of columns;
wherein a set of statistics are calculated for each of the plurality of columns of the data set;
wherein, based on each set of statistics for each of the plurality of columns, a score is generated for each column of the plurality of columns;
wherein a set of the plurality of columns is selected, the selection being based upon the score for each column;
wherein a plurality of data visualizations are generated for the selected set of the plurality of columns; and
wherein a set of the plurality of data visualizations is selected, based upon a set of rules, for display via a user interface.

2. The system of claim 1, wherein the score generated for each column of the plurality of columns utilizes a configurable set of rules that operate on each set of statistics for each of the plurality of columns of the data set.

3. The system of claim 1, wherein the set of rules utilized to select the plurality of data visualizations for display via the user interface comprises rules that score data visualizations with high visual contrast higher that data visualizations with low visual contrast.

4. The system of claim 1, wherein each of the selected set of the plurality of columns comprises one of a measure and a metric.

5. The system of claim 1, wherein a cardinality of each of the plurality of columns is utilized in generating the score for each of the plurality of columns.

6. The system of claim 5, wherein a null percentage is further utilized in generating the score for each of the plurality of columns.

7. The system of claim 1, wherein the generation of the plurality of data visualizations comprises a plurality of data visualization types.

8. The system of claim 7, wherein at least one of the generated plurality of data visualizations comprises a data visualization type selected based upon the set of statistics calculated for a column represented in the at least one of the generated plurality of data visualizations.

9. A method for generating automatic insights of analytics data, comprising:
providing a computer including one or more processors, that provides access by an analytic applications environment to a data warehouse for storage of data by a tenant;
receiving, at the analytic applications environment, a data set comprising a plurality of columns;
calculating a set of statistics for each of the plurality of columns of the data set;
based on each set of statistics for each of the plurality of columns, generating a score for each column of the plurality of columns;
selecting a set of the plurality of columns, the selection be based upon the score for each column;
generating a plurality of data visualizations for the selected set of the plurality of columns; and
selecting a set of the plurality of data visualizations, based upon a set of rules, for display via a user interface.

10. The method of claim 9, wherein the score generated for each column of the plurality of columns utilizes a configurable set of rules that operate on each set of statistics for each of the plurality of columns of the data set.

11. The method of claim 9, wherein the set of rules utilized to select the plurality of data visualizations for display via the user interface comprises rules that score data visualizations with high visual contrast higher that data visualizations with low visual contrast.

12. The method of claim 9, wherein each of the selected set of the plurality of columns comprises one of a measure and a metric.

13. The method of claim 9, wherein a cardinality of each of the plurality of columns is utilized in generating the score for each of the plurality of columns.

14. The method of claim 13, wherein a null percentage is further utilized in generating the score for each of the plurality of columns.

15. The method of claim 9, wherein the generation of the plurality of data visualizations comprises a plurality of data visualization types.

16. The method of claim 15, wherein at least one of the generated plurality of data visualizations comprises a data visualization type selected based upon the set of statistics calculated for a column represented in the at least one of the generated plurality of data visualizations.

17. A non-transitory computer readable storage medium having instructions thereon, which when read and executed by a computer including one or more processors cause the computer to perform a method comprising:
providing a computer including one or more processors, that provides access by an analytic applications environment to a data warehouse for storage of data by a tenant;
receiving, at the analytic applications environment, a data set comprising a plurality of columns;
calculating a set of statistics for each of the plurality of columns of the data set;
based on each set of statistics for each of the plurality of columns, generating a score for each column of the plurality of columns;
selecting a set of the plurality of columns, the selection be based upon the score for each column;
generating a plurality of data visualizations for the selected set of the plurality of columns; and
selecting a set of the plurality of data visualizations, based upon a set of rules, for display via a user interface.

18. The non-transitory computer readable storage medium of claim 17,
wherein the score generated for each column of the plurality of columns utilizes a configurable set of rules that operate on each set of statistics for each of the plurality of columns of the data set; and
wherein the set of rules utilized to select the plurality of data visualizations for display via the user interface comprises rules that score data visualizations with high visual contrast higher that data visualizations with low visual contrast.

19. The non-transitory computer readable storage medium of claim 17,
wherein a cardinality of each of the plurality of columns is utilized in generating the score for each of the plurality of columns; and
wherein a null percentage is further utilized in generating the score for each of the plurality of columns.

20. The non-transitory computer readable storage medium of claim 17,
wherein the generation of the plurality of data visualizations comprises a plurality of data visualization types; and
wherein at least one of the generated plurality of data visualizations comprises a data visualization type selected based upon the set of statistics calculated for a column represented in the at least one of the generated plurality of data visualizations.
